(19) United States
(12) Patent Application Publication
(10) Pub. No.: US 2011/0126237 A1
(43) Pub. Date: May 26, 2011

(54) EDITING MENU FOR A NETWORK TELEVISION

(76) Inventors: Hyung Nam LEE, Seoul (KR); Uni Young Kim, Seoul (KR); Sang Jun Koo, Seoul (KR); Sae Hun Jang, Seoul (KR); Kyung Hee Yoo, Seoul (KR)

(21) Appl. No.: 12/902,547

(22) Filed: Oct. 12, 2010

(30) Foreign Application Priority Data
Nov. 24, 2009 (KR) 10-2009-0113968

(51) Int. Cl. H04N 5/445

(52) U.S. Cl. 725/46

(57) ABSTRACT

A network TV includes a network interface, a user interface, and a controller. The network interface establishes a connection with at least one content provider server through a network. The user interface receives an input signal selecting an icon for display. The controller controls output of the selected icon for display along with an image corresponding to the selected icon. The selected icon corresponds to the content provider and is displayed with one or more other icons that correspond to additional content providers, and the image is based on information received through the network interface from the content provider. Further, a main menu on the display includes a background image and/or icons that display various types of information. The displayed background image and/or icons may be changed or customized.

### CROSS-REFERENCE TO RELATED APPLICATION(S)

The present application claims the benefit of priority under 35 U.S.C. 119 to Korean Patent Application No. 10-2009-0113968 filed in Korea on Nov. 24, 2009 which is hereby incorporated by reference in its entirety.

### BACKGROUND

1. Field

A network television and a method of controlling the same are disclosed herein.

2. Background

Network televisions and methods of controlling the same are known. However, they suffer from various disadvantages.

### BRIEF DESCRIPTION OF THE DRAWINGS

The embodiments will be described in detail with reference to the following drawings in which like reference numerals refer to like elements, wherein:

FIG. 1 shows one embodiment of a network TV system;

FIG. 2 shows an example of a network TV;

FIG. 3 shows an example of the network TV that generates a three-dimensional image;

FIGS. 4 and 5 show an example of a remote controller or pointing device that controls the network TV shown in FIG. 2 or 3;

FIG. 6 shows one embodiment of the internal structure of an interface unit of the network TV shown in FIG. 1 and a motion recognition remote controller included for the network TV in FIG. 3;

FIG. 7 shows one embodiment of a menu screen displayed on the network TV;

FIGS. 8 and 9 show examples of menu screens that may be generated in accordance with the embodiments described herein;

FIGS. 10 to 15 show various menu screens, background images, and/or effects generated in accordance with one or more embodiments herein;

FIG. 16 is a flowchart of a method for displaying media information in accordance with one or more embodiments described herein;

FIGS. 17 to 20 show screens that include various types of messages or advertisement images that may be generated in accordance with one or more embodiments described herein;

FIG. 21 is a flowchart of a method for displaying a message or advertisement image in accordance with one or more embodiments described herein;

FIGS. 22 and 23 show screens that display effects performed in accordance with one or more embodiments described herein;

FIG. 24 is a flowchart of a method for performing effects in accordance with one or more embodiments disclosed herein;

FIGS. 25 to 30 show screens containing background images that change based on condition information of a user or a network TV in accordance with one or more embodiments disclosed herein;

FIG. 31 is a flowchart of a method for changing a background image in accordance with one or more embodiments disclosed herein;

FIGS. 32 to 34 show screens that display notifications of various problems encountered during operation of the network TV;

FIG. 35 is a flowchart of a method of displaying problems on a menu screen in accordance with one or more embodiments disclosed herein;

FIG. 36 shows another embodiment of a menu screen that is displayed at a same time a television signal is displayed;

FIG. 37 shows an example of a menu screen according to an embodiment of the present disclosure;

FIG. 38 shows templates constituting a menu screen according to an embodiment of the present disclosure;

FIGS. 39 and 40 show an example of changing the configurations of templates according to an embodiment of the present disclosure;

FIGS. 41 and 42 show an example of changing the positions of templates or changing an image displayed in a template according to an embodiment of the present disclosure;

FIG. 43 shows an example of toggling between a default menu screen and user menu screens according to an embodiment of the present disclosure;

FIG. 44 shows an example of changing a menu screen by using a motion recognition remote controller according to an embodiment of the present disclosure;

FIG. 45 is a flowchart showing a method of editing a menu screen according to an embodiment of the present disclosure; and

FIG. 46 is a flowchart showing a method of storing a plurality of menu screens and changing or toggling the menu screen according to an embodiment of the present disclosure.

### DETAILED DESCRIPTION

Internet content may be provided on various types of display devices. One type of technology is Internet Protocol TV (IPTV), which seeks to transmit video, audio, and other forms of digital content to televisions through a high-speed Internet connection. Other types of technology may include broadband TV and web TV. Unlike IPTV, broadband and web TV may provide media information (e.g., VOD, game, visual telephone services, etc.) from several content providers. Further, a network TV as broadly described and embodied herein may optimize delivery of content to television users, and may also offer users with creative ways of controlling and navigating through the selection, viewing, and previewing of Internet content and of reviewing advertisement information.

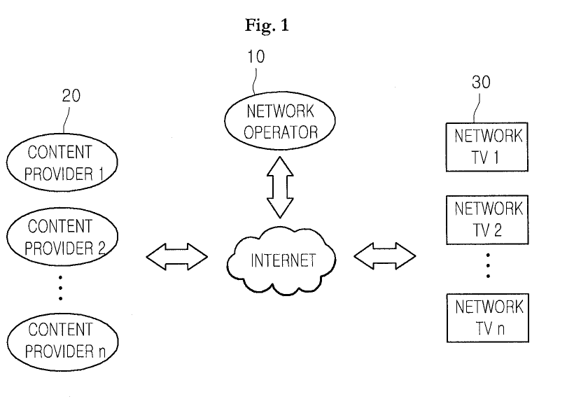

FIG. 1 shows one embodiment of a network TV system which may include a network operator 10, at least one content provider 20, and at least one network TV 30, which may be connected by a network, for example, the Internet. The network operator 10 may provide software, firmware, middleware, and/or other software routines that controls output of content provided by the content provider in the network TV 30, as well as application software for use during operation of the network TV 30. Further, the content provider may be provided with hardware information in association with the network TV 30 which may be used during normal execution of content in the network TV 30.

For example, the network operator may provide a basic screen frame for providing content provided by the content provider 20 to the network TV 30, and may provide a user interface to allow a user to select content, input various commands, or display a corresponding output. Further, the network operator may also provide data for updating firmware or software of the network TV 30. The network operator may also be the same as the manufacturer of the network TV 30.

The content provider 20 may generate various contents that may be provided on the network, form them in a format that may be played in the network TV 30, and then provide the content in accordance with a request of the network TV 30. The content may be any multimedia content that may be serviced through the network. According to one embodiment, the content provided by the content provider 20 may be provided directly to the network TV 30 through the Internet by the content provider 20 or via a network operator or administrator.

The network TV 30 may be provided with exclusive firmware for displaying content, searching, and displaying a list for each content provider 20. The firmware may be installed on the network TV 30 during manufacture of the network TV 30, or downloaded from the content provider 20 or the network operator for installation by a user.

The firmware of the network TV 30 may also include a program that plays or executes the content provided by the content provider 20. The firmware may be changed in accordance with various types of content provided by the content provider 20. For example, when the content provider 20 is a Video On Demand (VOD) provider, the firmware may include a VOD play program. Moreover, when the content provider 20 is an Audio On Demand (AOD) or Music On Demand (MOD) provider, the firmware may include an AOD or MOD play program. When the content provider 20 is a visual telephone provider, the firmware may include a visual telephone program.

The network TV 30 may receive content from the content provider 20 and plays or executes the content. The network TV 30 may be a TV equipped with a network module, a broadcast receiver such as a set top box, or any other type of display device equipped with a network module, for example, a network telephone. Simply for ease of explanation, a broadcast receiver that receives a broadcast signal is exemplified herein. However, embodiments broadly disclosed and embodied herein may be applied to any display device that may be connected to a network.

According to one embodiment, the content provider 20 may be a provider that makes or distributes a variety of content that will be provided to the network TV 30. The content provider 20 may, for example, include a TV broadcasting station, a radio station, a VOD provider, an AOD provider, a game provider, a visual telephone provider, a weather information provider, a photograph-related service provider, or other appropriate media content provider 20.

The TV broadcasting station may be a terrestrial or cable broadcasting station which may produce and store programs that users may watch and/or convert into a digital format for transmission. The radio broadcasting station may provide audio content with or without video content. The VOD provider and the AOD provider may have characteristics different from the TV broadcasting station or the radio broadcasting station. That is, the VOD or AOD provider may provide a service that allows a user to store and play desired broadcast programs, movies, music, and/or other media content.

For example, when a user cannot watch a desired live broadcast program, the user may download or play the corresponding media file at a website of the content provider 20 that provides this broadcast service. The AOD provider may provide streaming audio content. A MOD service provider may allow a user to download music. Further, a visual telephone provider may provide a relay service such that a user may make a video telephone call with a user of another network TV 30 over a network. A weather information provider may provide information on several local areas and a photograph-related service provider may provide a tool for editing and storing photographs.

The content provider 20 may also be any service provider that provides various services to the network TV 30 through the Internet, such as a PF (Packet Filter) server, an Electronic Program Guide (EPG) service provider, an Electronic Content Guide (ECG) service provider, a portal server operator, or other appropriate service providers.

The PF server may be serviced by an enterprise that manages all broadcast information and location information, etc., which are provided by the content provider 20. This service may contain, for example, broadcasting times or schedules of a corresponding broadcast station, location information needed for broadcasting, and contact information of the provider.

The EPG service provides EPG information that allows a user to search broadcast programs based on time and/or channel. The ECG service may provide a user with information regarding content available from the content provider 20, a location of a connection server, and access authority to the connection server. That is, it is an electronic program guide that may provide detailed information that allows for easily connecting to servers having the content as well as information regarding the content.

The portal server may be a web service provided from each broadcast station, and may be connected to a web server of a broadcast station or an enterprise that services content when receiving a request from a user terminal. The portal server may allow searching of a program list provided by a broadcast station or content provider 20.

The network TV 30 has a network interface for connecting with a network to receive and process data packets through the network using an assigned IP address, and may store or play the data packet when the data packet is multimedia data, such as video or audio data. The network TV 30 may bilaterally transmit a user request while processing multimedia data. Further, buttons for controlling the network TV 30 (e.g., buttons for selecting various menus) may be provided on an input device such as a remote controller that controls the network TV 30.

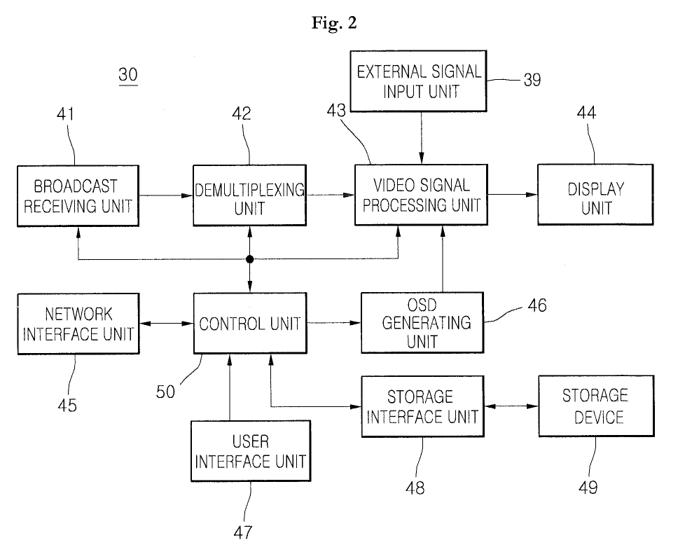

FIG. 2 shows one embodiment of the network TV 30. In addition to the function of receiving content through a network, the network TV 30 may be provided with a function of receiving RF signal type broadcast signals by wireless communication or through a cable. According to one embodiment, the network TV 30 may include a broadcast receiving unit 41, demultiplexing unit 42, video signal processing unit 43, display unit 44, a network interface unit 45, OSD generating unit 46, user interface unit 47, storage interface unit 48, storage device 49, external signal input unit 39, and a control unit 50.

The broadcast receiving unit 41, demultiplexing unit 42, and video signal processing unit 43 may be formed in one broadcast processing unit that receives broadcast signals and processes them into a type or format which may be outputted to the display unit 44 by performing various processes. When content is provided by digital broadcast, digital broadcast signals may be transmitted in transport stream type packetized data by time-division multiplexing video signals, audio signals, and additional data.

The broadcast receiving unit 41 may include an antenna that receives broadcast signals, and may also include a tuner that tunes a broadcast signal having a corresponding frequency band in accordance with a tuning control signal of the control unit 50, as described below. The broadcast receiving unit 41 may also include a demodulator that outputs the broadcast signal of a predetermined tuned channel by performing a Vestigial Sideband (VSB) modulating process and an error correcting process to the broadcast signal.

The broadcast signal received by the broadcast receiving unit may be divided into various additional data defined as, for example, a video signal, an audio signal, and a Program and System Information Protocol (PSIP) information by the demultiplexing unit, and then outputted in a bit stream. The video data separated by the demultiplexing unit are processed by the video signal processing unit 43 and displayed by the display unit 44. The video signal processing unit 43 may include an MPEG-2 decoder and a scaler that converts the video data to meet vertical frequency, resolution, screen ratio, etc., corresponding to output standards of the display unit 44.

The display unit 44 may be any one of a variety of displays such as a Digital Light Processing (DLP), an Liquid Crystal Display (LCD), Plasma Display Panel (PDP) or other appropriate types of displays. Further, the audio signal may be processed by a voice signal processing unit and outputted from a speaker, in which the voice signal processing unit may include an AC-3 decoder.

The additional data included in the additional data separated by demultiplexing unit 42 may be stored in storage device 49 through storage interface unit 48. The storage device may be implemented by an electrically erasable programmable read-only memory (EEPROM), or other appropriate types of storage or memory devices.

The user interface unit 47 may receive a request instruction from a user and generally may include an infrared receiving unit that receives an infrared signal inputted by a remote controller or a local key input unit disposed at one side of a panel. The network interface unit 45 receives content or data from the content provider 20 or the network operator through the network. That is, the network interface unit may receive content such as broadcast, games, VODs, broadcast signals, provided from the content provider 20 and the associated information. Further, network interface unit 45 may receive updates such as firmware updates which the network operator may provide.

The On Screen Display (OSD) generating unit 46 may generate a menu screen that receives the user's determination signal in an OSD. That is, the OSD generating unit 46 may display content, received through network interface unit 45, and the associated information through the display unit.

The external signal input unit 39 is an interface that may receive an input from other players, for example, DVD players or game consoles. It may be possible to output multimedia stored in other players to the display unit 44 by connecting the players to the external signal input unit. The control unit 50 may perform control operations in accordance with instructions input from user interface unit 47. The control unit may also receive and execute software of the content provider 20 received from the network operator, for example, a firmware update.

According to one embodiment, broadcast receiving unit 40 may output a 3D-image. The menu screen of the broadcast receiving unit may be provided in 3D and may also receive and output 3D-content when the content is provided by the content provider 20 in 3D. Additional components may be used in generating 3D-images.

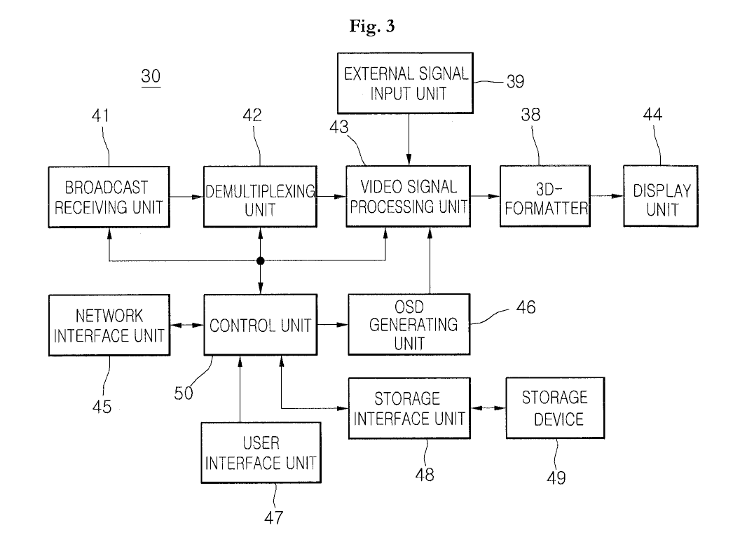

FIG. 3 shows one embodiment of a broadcast receiving device that may be used to process a 3D-image. The operation of the components shown on FIG. 3 other than the 3D-formatter 38 is the same as that of FIG. 2. Referring to FIG. 3, the 3D-formatter 38 may be disposed at an output end of video signal processing unit 48. The 3D-formatter 38 may convert the image processed by the video signal processing unit into a 3D-image and may transmit it to display unit 44. According to one embodiment, a specific 3D-formatter that converts an OSD output into 3D may be included in the OSD generating unit 46. Other techniques may also be used to process a 3D-image.

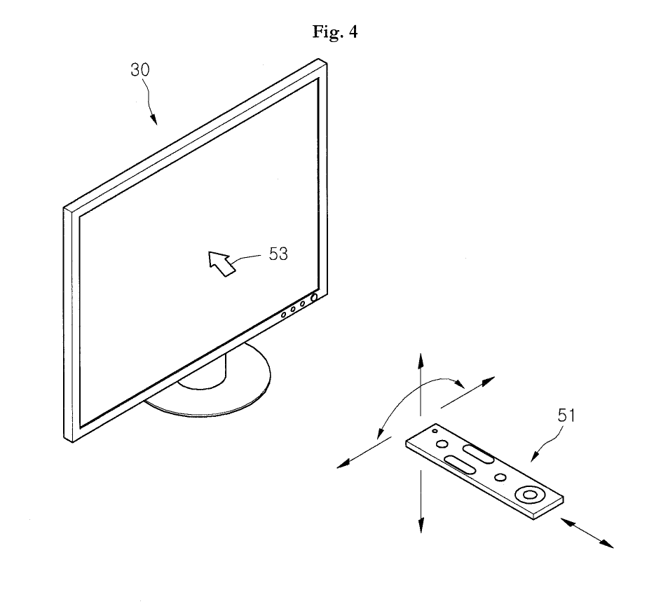

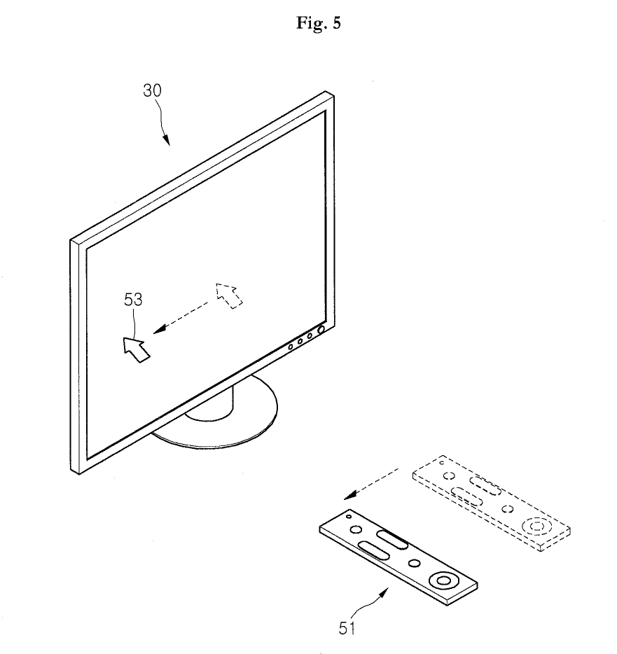

FIGS. 4 and 5 show examples of a remote controller for controlling the network TV 30 shown in FIG. 2 or FIG. 3. The remote controller may transmit a control signal to control unit 50 through a wireless signal receiver that may be included in user interface unit 47 of the network TV 30 and receive wireless signals, such as an RF signal or an infrared signal. The remote controller described with reference to FIGS. 4 to 5 may be a remote controller that responds not only to a selection of a button by a user but also to a user's gesture, hereafter referred to as a motion recognition remote controller 51.

According to one embodiment, the motion recognition remote controller 51 may transmit/receive a signal to/from the network TV 30 in accordance with an RF communication regulation. As shown in FIG. 4, a pointer 53 may be displayed at a position pointed by the motion recognition remote controller 51 on the network TV 30.

A user may move or rotate the motion recognition remote controller 51 up/down, left/right, and forward/backward. The pointer displayed on the network TV 30 may respond to the movement of the motion recognition remote controller 51. FIG. 5 shows how a pointer displayed on the network TV 30 may move in response to the movement of the motion recognition remote controller 51. As shown in FIG. 5, when a user moves motion recognition remote controller 51 to the left, the pointer displayed on the network TV 30 also moves to the left.

In this embodiment, the motion recognition remote controller 51 may have a sensor that recognizes movement. Information on movement of the motion recognition remote controller 51 which has been detected by the sensor of the motion recognition remote controller 51 is transmitted to the network TV 30. The network TV 30 may determine movement of the motion recognition remote controller 51 on the basis of the information on the movement of the motion recognition remote controller 51 and may calculate corresponding coordinates of pointer 53. An acceleration sensor, a gyrosensor, a geomagnetic sensor, or other appropriate sensors may be used to recognize the movement.

FIGS. 4 and 5 show an embodiment in which the pointer moves in response to up/down and left/right movement or rotation of the motion recognition remote controller 51. The movement velocity or direction of the pointer 53 may correspond to the movement velocity or direction of the motion recognition remote controller 51.

In this embodiment, a pointer 53 displayed on the network TV 30 may move in response to motion of the remote controller 51. According to one example, a predetermined instruction may be input to the TV in response to motion of the remote controller 51. For example, when the motion recognition remote controller 51 moves forward or backward, the size of an image displayed on the network TV 30 may be increased or decreased accordingly.

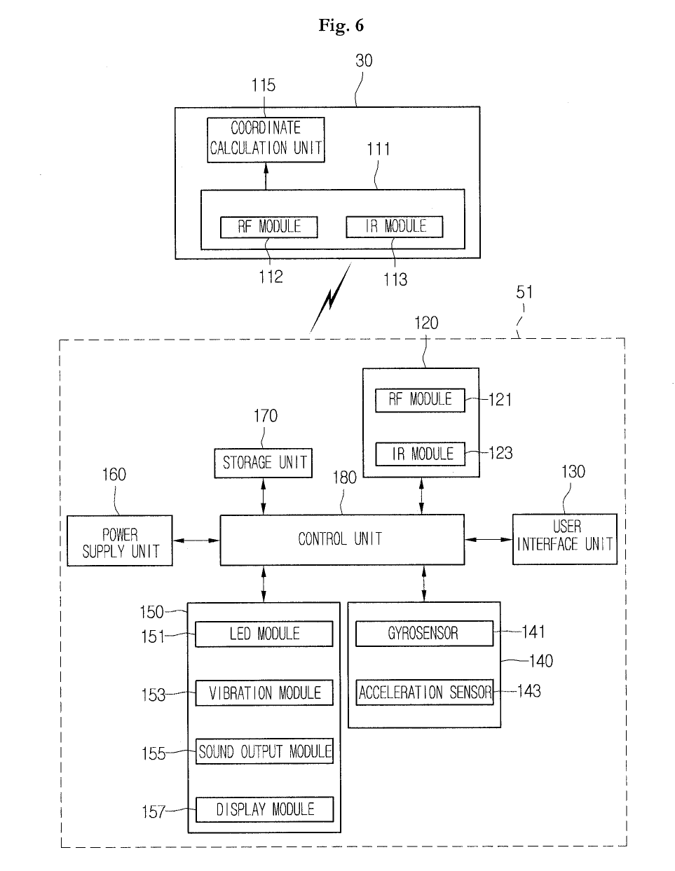

FIG. 6 shows one embodiment of interface unit 47 of the network TV 30 of FIG. 1 and motion recognition remote controller 51 of FIG. 4. As shown, the network TV 30 may include a coordinate calculation unit 115 and a wireless communication unit 111. The coordinate calculation unit 115 may be included in the control unit 50. The wireless communication unit 111 may be included in the user interface unit 47. The wireless communication unit 111 may include an RF module 112 or an IR module 113. The motion recognition remote controller 51 may include a wireless communication unit 120, a user input interface unit 130, a sensor unit 140, an output unit 150, a power supply unit 160, a memory 170, and a control unit 180.

The wireless communication unit 120 transmits/receives a signal to/from the network TV 30. The motion recognition remote controller 51 may have an RF module 121 that may transmit/receive a signal to/from the interface unit 47 of the network TV 30 under the RF communication regulation. Further, the motion recognition remote controller 51 may have an IR module 123 that may transmit/receive a signal to/from the user interface unit 47 of the network TV 30 under the IR communication regulation.

The motion recognition remote controller 51 may transmit a signal carrying information on motion of motion recognition remote controller 51 to the network TV 30, using RF module 121. Further, the motion recognition remote controller 51 may receive a signal transmitted from the network TV 30, using the RF module 121. Further, the motion recognition remote controller 51 may transmit, if needed, an instruction for power-on/off, a channel change, a volume change, etc. to the network TV 30 using the IR module 123.

The user interface unit 130 may include a key pad or buttons. A user may input an instruction relating to the network TV 30, using the motion recognition remote controller 51, by operating the user interface unit 130. When the user input unit has a hard key button, a user may input an instruction relating to the network TV 30, using motion recognition remote controller 51, by pressing the hard key button.

When the user interface unit 130 has a touch screen, a user may input an instruction relating to the network TV 30, using motion recognition remote controller 51, by touching the soft key of the touch screen. Further, the user interface unit 130 may have a variety of input devices that a user may operate such as a scroll or jog key or other input devices.

The sensor unit 140 may include a gyrosensor 141 or acceleration sensor 143 to sense motion. The gyrosensor may detect movement of the motion recognition remote controller 51. For example, the gyrosensor 141 may sense information related to movement of the motion recognition remote controller 51 about the x, y, and z axes. The acceleration sensor 143 may sense, for example, information related to movement velocity of the motion recognition remote controller 51. The output unit 150 may output an image or voice signal corresponding to an operation of the user interface unit 130 or a signal transmitted from the TV 30. A user may recognize whether the interface unit 130 is operated or TV 30 is controlled from output unit 150.

For example, the output unit 150 may include one or more of an LED module 151 that is turned on/off, a vibration module 153, a voice output module 155, or a display module 157 that outputs video. The output unit 150 may be activated when the user input unit 130 is operated or when the network TV 30 transmits/receives a signal to/from wireless communication unit 120.

The power supply unit 160 may supply power to motion recognition remote controller 51. The power supply unit 160 may reduce the waste of power by disconnecting power when the motion recognition remote controller 51 has not moved for a predetermined period of time. The power supply unit may start again to supply power when a predetermined key of the motion recognition remote controller 51 is operated.

The memory 170 may store various types of application data for operating or controlling motion recognition remote controller 51. The motion recognition remote controller 51 may transmit/receive a wireless signal in a predetermined frequency band to/from the network TV 30 using the RF module 121, transmit/receive a signal. The control unit 180 of the motion recognition remote controller 51 may store in memory 170 information related to the frequency band of the wireless signal between the network TV 30 and the paired motion recognition remote controller 51. The control unit 180 of the remote controller may transmit a signal corresponding to the operation of a predetermined key of user input unit 130 or a signal corresponding to operation of the remote controller sensed by sensor unit 140 to the wireless communication unit 111 of the TV using wireless communication unit 120.

The network TV 30 may include a wireless communication unit 111 that transmits/receives a wireless signal to/from the motion recognition remote controller 51 and the coordinate calculation unit 115 that calculates coordinates of the pointer 53 which corresponds to a position of the motion recognition remote controller 51. The wireless communication unit 111 may transmit/receive a wireless signal to/from the motion recognition remote controller 51 using the RF module 112. Further, it may receive a signal transmitted from the motion recognition remote controller 51, using the RF module 112, under the IR regulation. The coordinate calculation unit 115 may calculate coordinates (x,y) of the pointer 53 that will be displayed on the display 49, after correcting for hand tremble or other errors, on the basis of a signal corresponding to motion of the motion recognition remote controller 51 which has been received through the wireless communication unit 111.

Further, the signal transmitted from the motion recognition remote controller 51 to the network TV 30 through the interface unit 47 may be transmitted to the control unit 50 of the network TV 30. The control unit 50 may recognize information regarding key operation and motion of the motion recognition remote controller 51 on the basis of the signal transmitted from the motion recognition remote controller 51. The control unit 50 may control the network TV 30 on the basis of the recognized result.

A menu screen of the network TV 30 and a method of operating the menu screen is described hereinbelow. According to one embodiment, the ‘menu screen’ of the network TV 30 may be an initial screen or a main screen when the network TV 30 enters an operation mode that provides a menu allowing the network TV 30 to select and connect with one of a plurality of content providers 20. The menu screen may include a plurality of icons representing a plurality of content providers 20, and may also include a background image having a specific subject. Simply for ease of explanation, the embodiments will be described hereinafter with the operation mode being a NetCast™ mode.

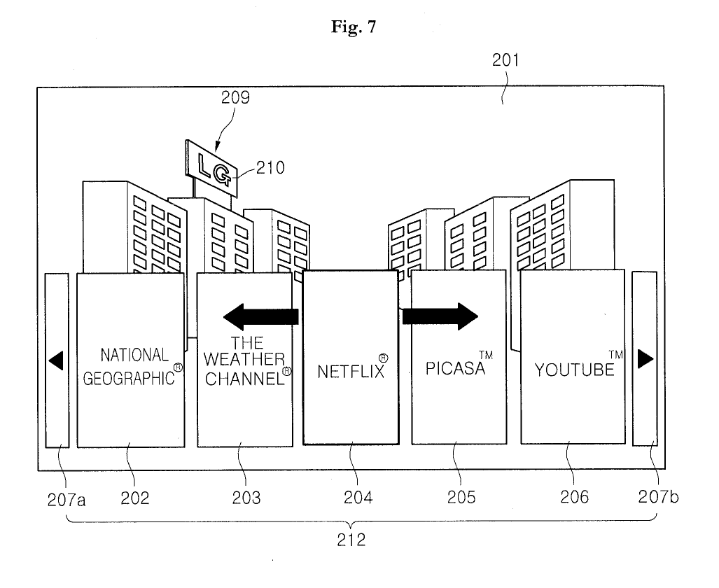

FIG. 7 shows an example of a menu screen 200 which may be generated on the network TV 30. In this example, an image of a city is shown as the background image 201 of the menu screen 200 and a plurality of icons 212 representing content providers 20 are shown over the main screen. The image of the menu screen may include any type of theme, location, specific subject, or other features or any combination thereof, including but not limited to various subjects such as a jungle, department store, beach, universe, and/or scene of fairy tales. The background image 201 may also include graphical objects that may be displayed, for example, by selectively inserting a basic and/or other images corresponding to a subject. The icons 212 may correspond to one or more buttons for connecting with a respective number of content providers 20, and a user may access one or more desired services from a content provider 20 by selecting one of the icons 212.

Additionally, the icons 212 may relate to the background image 201. According to one example, the icons 212 may be graphical objects corresponding to a subject or other feature in the background image. For example, icons 212 may be displayed in a shape of a structure or a billboard on a road of a city. The images displayed on the icons may be provided by one or more of the content providers 20 and/or based on information stored within the network TV 30 or other external sources. A user may use motion recognition remote controller 51 to select the icons 212.

When background image 201 (e.g., an image of a location or area) is changed based on, for example, user information, the icons 212 and/or the images displayed on the icons 212 may be changed accordingly. For example, the content providers 20 corresponding to the icons 212 may include or contain National Geographic® 202, The Weather Channel® 203, Netflix® 204, Picasa™ 205, and YouTube™ 206, as shown in FIG. 7. The images displayed on each icon may represent each respective content provider 20. Moreover, the National Geographic® provider may provide science content, The Weather Channel® 203 may provide weather information corresponding to a specific area, Netflix® may provide movie content, Picasa™ may provide photographs or other related content, and the YouTube™ may provide VOD content.

According to one embodiment, various types and/or numbers of icons may be additionally displayed on the menu screen. Scroll bars 207a and 207b may be disposed at left and right sides of the icons 212 to allow additional icons to be displayed when a user selects the scroll bars.

According to another embodiment, an image display region 209 where another image may be displayed may be defined at a portion of the background image such that it is possible to display other images showing an advertisement image 210 or a message in the image display region 209. The advertisement image 210 may include an advertisement and/or other image that may include predetermined information corresponding to a guide message. The advertisement information 210 or other images may be provided by the network operator and/or the content providers 20.

According to another embodiment, the image display region 209 may be disposed at a predetermined position of background image 201, and may also be disposed at an appropriate position in consideration of a subject or other feature in the background image 201. For example, as shown in FIG. 7, image display region 209 may be disposed at an outdoor sign board position, for example, a billboard, and an advertisement image 210 may be displayed.

The image display region 209 may have various shapes in accordance with the subject or other features in the background image 201. For example, when the subject of the background image 201 is a park, the image display region 209 may show a pond or a tree that is commonly seen in a park, or when the subject of the background image 201 is a department store, the image display region 209 may be a display window that is commonly seen at a department store.

As previously described, a message or advertisement 210 may displayed in a creative manner to engage the attention of a user. This may be accomplished, for example, by displaying an image in image display region 209 to be harmonized with the background image 201. Detailed and various methods of displaying a message or an advertisement in the image display region 209 are described below.

When a user selects one of the icons 212, for example, the Netflix® icon 204, the selected icon is highlighted so as to discriminate it from the other icons. The icon may be selected using an arrow or cursor on the screen that may be controlled by the motion recognition remote controller 51. When another icon is selected, the other icon may be highlighted and the previous icon deemphasized. With the icon selected, when a button of the remote controller is pressed, for example, the ENTER button, a connection may be established with the server of the content provider 20 corresponding to the selected icon and an initial or predetermined screen of the server of the content provider 20 may be displayed.

The number, size, position, and/or arrangement of icons displayed on one screen may vary in different applications or embodiments. The icons 212 may include or may be associated with a name or image to distinguish among the content providers 20. In addition, each network TV 30 may store in an internal memory device a number of built-in icons, images, or other features provided, for example, by the TV manufacturer. Additionally, network operator 10 may provide each network TV 30 with images, information, or other features that correspond to the icons 212 from one or more content providers 20. New images, information, of features may be transmitted to the network TV 30 in this manner or images, information, and features already stored in the TV 30 may be updated. Further, the network TV 30 may directly connect with the servers of the content providers 20 for receiving or downloading images.

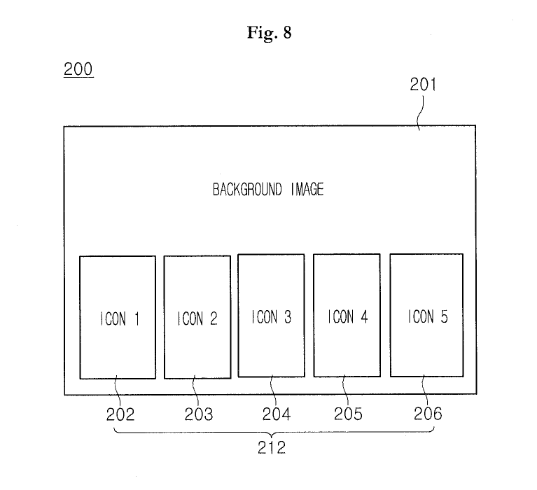

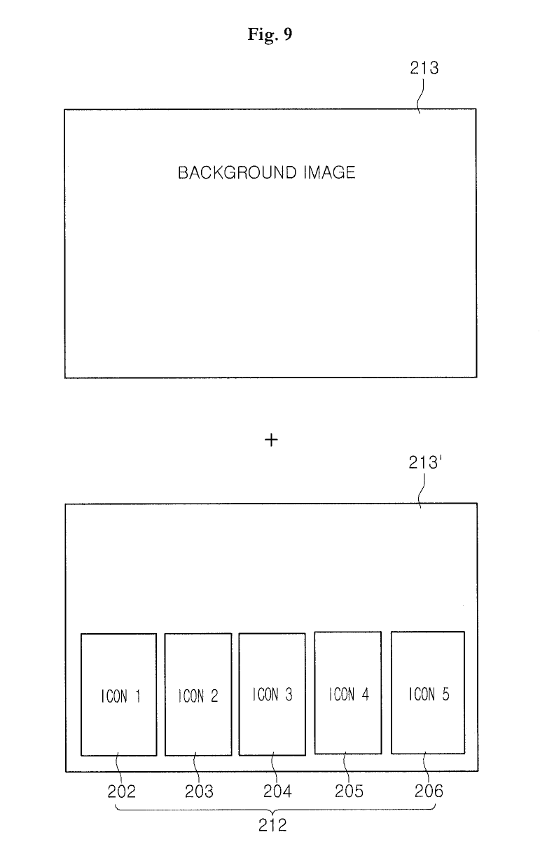

FIGS. 8 and 9 show examples of menu screens that include a background image 201 and icons 212. As shown in FIG. 9, one menu screen may include a number of icons 212 disposed over background image 201. The menu screen may be implemented by overlapping a layer 213 that includes the background image with a layer 213′ that includes the icons 212.

According to one embodiment, different effects may be applied to or associated with layers 213 and 213′. For example, the icons 212 may be translucently displayed to allow, for example, all or a portion of the background image 201 to be visible through the icons 212. Alternatively, only the background image 201 may be translucently displayed to allow the icons 212 to be visible through the background image 201. Other effects including animations, movement of graphical or animated objects or features, or other visual and/or audible effects may be provided in association with the icons 212 and/or background image 201.

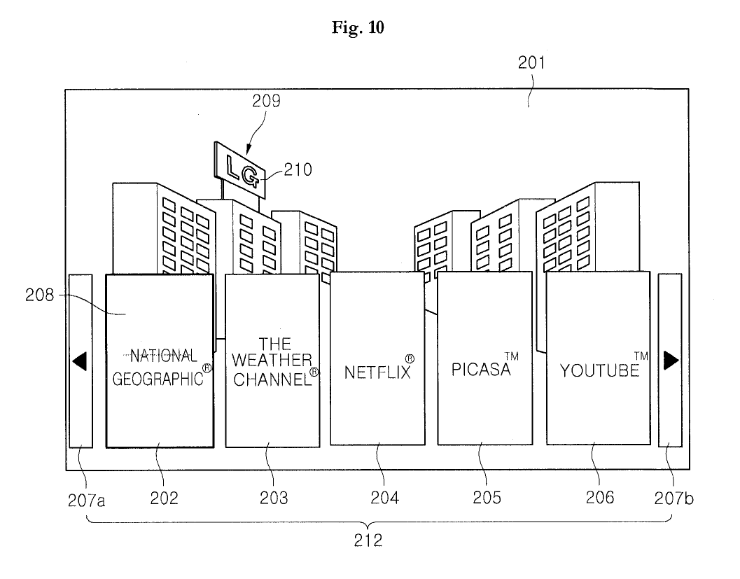

FIGS. 10 to 15 show additional examples of menu screens where various effects are applied to icons selected by a user. The effects may be performed when, for example, an icon is selected in the NetCast™ service or in another mode. One effect may involve displaying an image relating to a content provider 20 of one or more of the icons 212 (whether selected or not). The image may be one stored in the network TV 30 or in a unit coupled to the TV, and/or the image may be received through the network from a content provider 20. In the latter, the content provider 20 may control which image is to be displayed.

Another effect may be to display a video, animation, or a still image in association with the background image 201 and/or one or more of the icons 212. According to one embodiment, the content provider 20 may provide information needed to apply these effects directly to the network TV 30 or the effects may be made available from another manufacturer or party by request for direct or indirect transmission to the network TV 30 through the network operator 10 or other network entity.

Referring to FIG. 10, when a user selects the icon 202 corresponding to a national science provider, for example, National Geographic®, a video relating to subject matter associated with National Geographic® may be displayed in association with the national science icon 202 at another location. The video or another effect may be displayed while a current background image 201 and the images of the icons 212 are maintained.

For example, since the National Geographic® provides content relating to animals, when the National Geographic® icon 202 is selected, a video showing an animal 208 (e.g., an elephant walking in relation to one or more of the icons) may be displayed. Alternatively, a video showing an eagle flying in the sky in the background image or a video showing a variety of animals coming out from one side of the screen may be displayed. The video effects may be implemented using, for example, a flash program or other appropriate application programs.

The videos may relate to content providers 20 represented by icons 212 and may be controlled by the content providers 20. For example, content may be created by the content providers 20 or manufacturer, and by request may be transmitted through network operator 10 or directly to the network TV 30 for storage therein.

In accordance with another embodiment, a video that contains an animal moving in front of or around structures of a city in the background image 201 or icons 212 may be displayed. This may be an animation associated with the content provider 20. This effect may allow a user to acquire intuitive information on selected icons while providing fun and interesting viewing.

When a user presses a specific button of the motion recognition remote controller 51 (e.g., the ENTER button or the like) while a video is being played, a connection may be established with a server of the content provider 20 of National Geographic®. Through this connection, an initial or other predetermined screen of a service corresponding to National Geographic® may be displayed on the network TV 30. Thereafter, the user may be provided with content by selecting the content provided by National Geographic® on the screen.

The videos may be in a format that may be executed by the network TV 30 as provided by content provider 20 on the basis of, for example, system information or software of the network TV 30. This system information or software may be provided by the manufacturer of the network TV 30, either at the time of manufacture or during a download operation. The network TV 30 manufacturer may provide a user with a product having the software of the network TV 30 including the corresponding video such that the video may be played. According to another embodiment, the network TV 30 manufacturer may create a video and include it in the software of the network TV 30.

According to one embodiment, in the network system of FIG. 1, each content provider 20 may create a video and transmit it to network operator 10 after receiving system information of the network TV 30 from the network operator 10 or the network TV 30 manufacturer. The network operator 10 may transmit an updated file including the video file to the network TV 30 that may display the video as described above by executing the updated file. The displayed video may also be updated by the above method.

Further, according to an embodiment, an image that is displayed when an icon 202 is selected, may be changed in accordance with a time of day or a season of the year. Further, when a content provider 20 provides new content, it may be possible to display a video relating to the newly provided content. The video relating to the new content may be displayed by updating the video in the above method. Even if new content is not provided, a user may be permitted to use the NetCast™ service to periodically update the video.

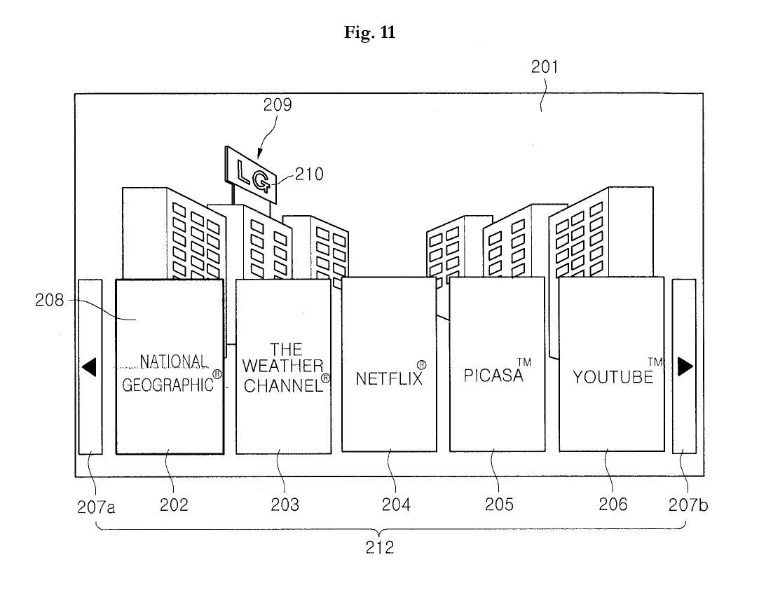

Further, according to an embodiment, it may be possible to display a three-dimensional image when an icon 202 is selected. For example, when the National Geographic® icon 202 is selected in FIG. 10, it is possible to provide an effect as if the elephant 208 is walking toward a user, as shown in FIG. 11. In this embodiment the icons or background image may be implemented in a 3D-image.

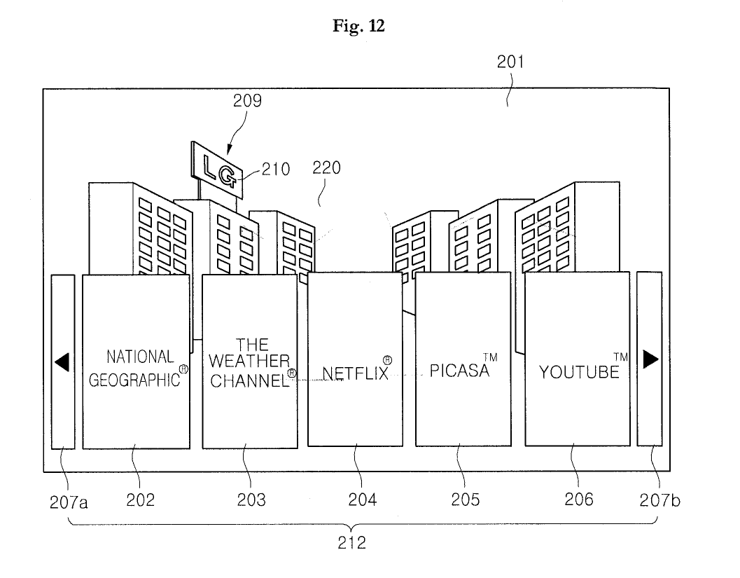

Referring to FIG. 12, according to one embodiment, when a user selects a content provider 20 which provides movie content (for example, icon 204 of Netflix®), a video relating to content provided by Netflix® may be displayed. The displayed video may relate to or be displayed in association with the background image 201 or icons 212. That is, one or more subjects or features in the video may be displayed in a way that makes it appear as if the subjects or features are moving within the environment of the city provided in the background image 201 and the icons 212.

For example, as shown in FIG. 12, it may be possible to display a video of the characters of the movie Toy Story. Further, according to one embodiment, the video may be made to display specific information. For example, assuming that Netflix® plans to provide service for the movie Toy Story on a specific date, for example, June 18, it is possible to display a video in which the characters throw up letters “J”, “U”, “N”, “E”, “1”, and “8” 220, one by one, over the structures, signs, or billboards relating to the icons 212. In this configuration, a user may recognize that the selected icon provides movie content and may be entertained while the content provider 20 advertises specific content. The video shown in FIG. 12 may be displayed by an animation implemented by a flash program and updated by the method described above. Further, the video of FIG. 12 may also be implemented and displayed in a 3D-image.

Similar to the embodiment shown in FIG. 10, when a user presses a specific button of the motion recognition remote controller 51, for example, an OK button while a video is displayed, it may be possible to display the initial screen by connecting with the Netflix® server. When another button (for example, a cancel button) is pressed, the displayed video may be stopped. It is possible to display information on the displayed video, that is, Toy Story, on the initial screen provided when connecting with the Netflix® server.

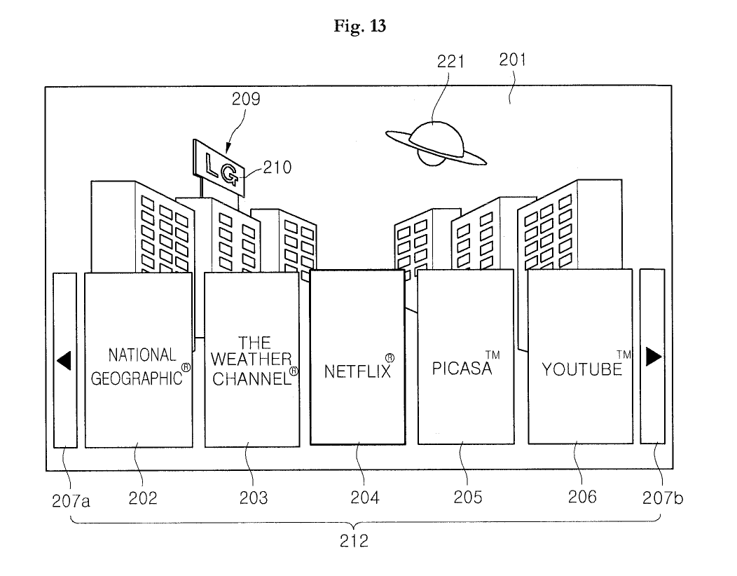

Referring to FIG. 13, when a user selects icon 204 for a content provider 20 of movies, for example, NetFlix®, it may be possible to display a video in which an object in a predetermined movie, for example, a spaceship 221 of Star Wars flies in the sky of the city background image 201. When the user presses a specific button while the spaceship 221 flies, it may be possible to connect with the Netflix® server to display an initial screen of Netflix®. It may be possible to display detailed information related to the displayed video, for example, the movie relating to the spaceship 221 or an advertisement video (e.g. a trailer), on the initial screen of the Netflix®. Further, the price of the content of Star Wars may be displayed during or after the advertisement video is played, and it may also be possible to download or stream the movie Star Wars to the network TV 30 if the user purchases the content.

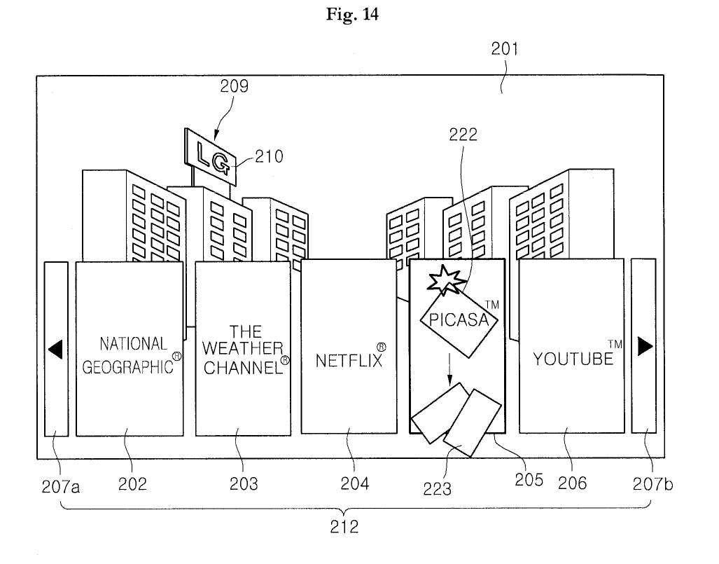

Referring to FIG. 14, when a user selects the provider of photograph content, for example, the Picasa™ icon 205, a video relating to photographs may be displayed. Similar to the embodiment described above, the displayed video or other effect may be activated in relation to the background image 201 or the icons 212 in the main screen.

For example, when a user selects Picasa™ icon 205, a sound of a shutter when taking a photograph may be output with a photograph frame 222 displayed in or around icon 205. In addition, or alternatively, an effect may be performed in which a photograph appears to fall down and is stacked with other photographs at a lower end 223 or in front of the icons. Similarly, when the user presses the OK button in the above state, a connection may be established with the Picasa™ server and an initial or predetermined screen of Picasa™ may be displayed.

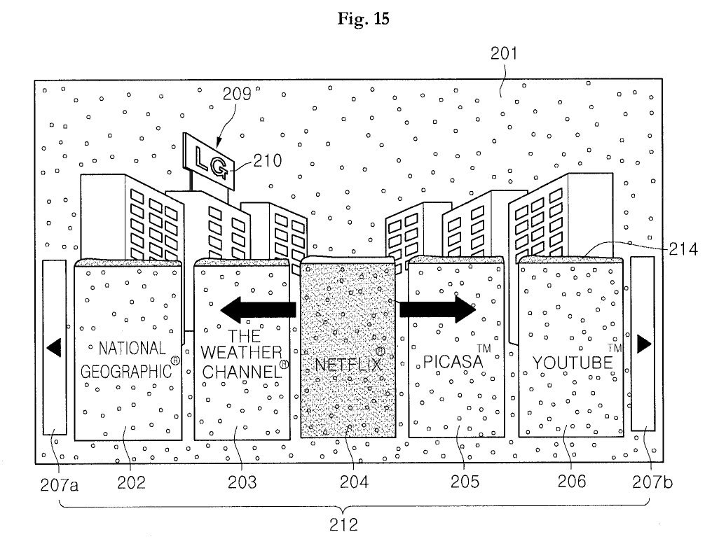

FIG. 15 shows an example of displaying a video or effect relating to weather over a background image 201 when a user selects an icon 203 corresponding to a weather information content provider 20. The effect may involve, for example, snow falling down over the city background image 201 and/or icons 212 in the menu screen. When icon 203 is selected, weather information may be received on the area where the network TV 30 is currently located. An effect corresponding to this weather information may then be displayed in the city included in background image 201. For example, an image where a sun is high in the sky may be displayed over the background image 201 when current or forecasted weather conditions are clear for the geographic area in which the network TV 30 is located. Alternatively, the screen may be darkened or a cloud image may be displayed when the weather conditions are cloudy, or an image showing rain may be displayed when rainy weather conditions are forecasted or exists. Also, an image showing snow may be displayed when snow is falling or is forecasted.

The weather information depends on the area information of the network TV 30, that is, the position or location of the network TV 30. The weather information content provider 20 may have all the weather information for the service area. After receiving the position information of the network TV 30, the weather information content provider 20 may transmit weather codes corresponding to the information to the network TV 30. The network TV 30 may store a video corresponding to each weather code, and load and display a video corresponding to the weather code received from the weather information content provider 20 when a user selects The Weather Channel® icon 203.

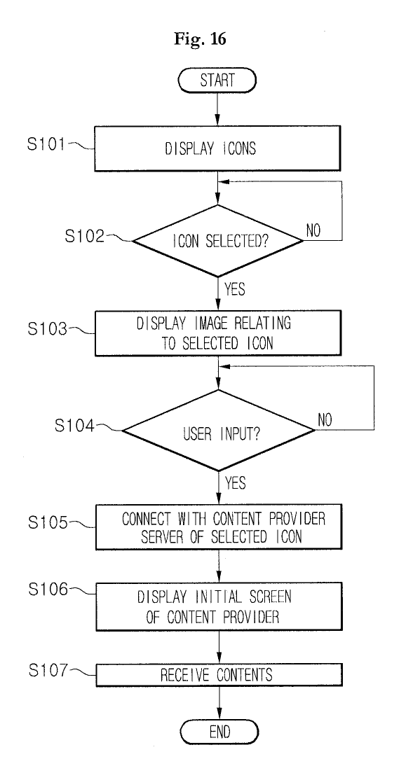

FIG. 16 shows operations included in one embodiment of a method for displaying a video in accordance with a selected icon in a menu screen including background image 201 and icons 212.

In step S101, a menu screen including icons representing content providers 20 is displayed. The background image may be displayed with the icons.

In step S102, a section of one of the icons by a user is detected.

In step S103, an image relating to the icon selected by the user is displayed. The image may be displayed while the background image and the icons are still displayed. The image may be a video, an animation, or still image, and may relate to the content provider 20 represented by the selected icon. For example, as described with reference to FIGS. 10 to 15, the image may be a video that relates to the icon or the corresponding content provider 20, and may be provided and controlled by the corresponding contents provider 20.

In step S104, when there is a user input while the image is displayed, in step S105, a connection with the server of the content provider 20 of the selected icon may be established. When there is no user input, the image may be kept repeatedly displayed, or a plurality of different videos may be sequentially displayed.

In step S106, the initial screen of the content provider 20, for example, a homepage of the server, is displayed, and in step S107, content is provided in accordance with the service that is usually provided by the network TV 30.

Meanwhile, according to one embodiment, an image including a message or an advertisement may be displayed on the menu screen of the network TV 30, regardless of a user input. The message may be an advertisement image of other images provided by the network operator 10 or contents provider 20.

As described above, background image 201 of the menu screen of the network TV 30 may include an image display region where an image may be displayed, and the image display region may be disposed at a predetermined fixed position or moved to other positions. A fixed-type display region may be disposed at a fixed position on the background image 201. For example, image display region 209 of FIG. 7 is set as a fixed type and an image such as an advertisement or other information may be selectively displayed in the image display region. The displayed message or advertisement 210 may be changed or updated by content provider 20 or network operator 10.

In another application, a movable image display region may move on or be adjusted relative to the background image. The image may not normally be displayed at this location on the menu screen, but may be displayed at this location on the menu screen by generating an interrupt in the control unit 50 of the network TV 30.

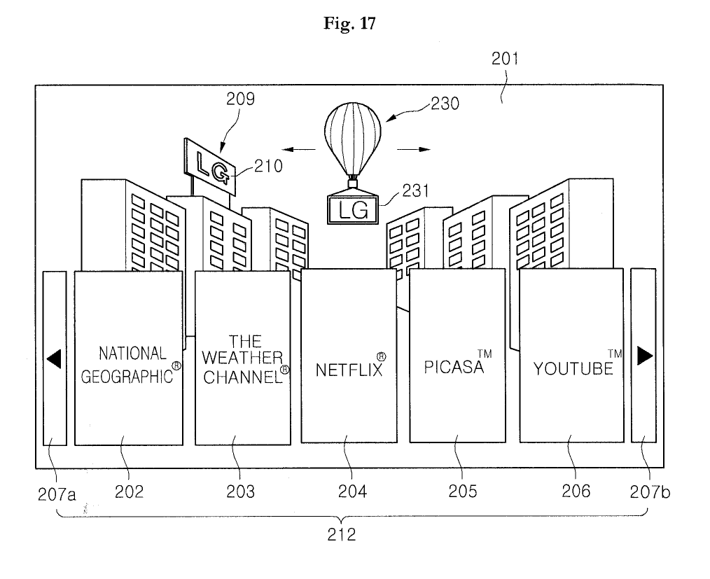

FIGS. 17 to 20 show additional menu screens that include a message or advertisement, displayed at a fixed or movable display region on a background image 201. Referring to FIG. 17, after a predetermined period of time passes with the menu screen displayed, a predetermined message or advertisement may be displayed on the menu screen, regardless of whether a user selects an icon 212. The image may be displayed in the movable image display region 230. Preferably, the image display region may relate to the subject of the background image. For example, when the subject of a background image 201 is a city as shown in FIG. 17, an image display region with a hot air balloon 230 flying in the sky may be used. The hot air balloon 230 may have a box 231 and the box may correspond to the image display region where a predetermined message or advertisement is displayed.

The image representing the movable image display region, that is, the hot air balloon 230 and box 231, may be provided by the network operator 10 and a message or an advertisement image that will be displayed in the movable image display region may be provided by network operator 10 or content provider 20. When an advertisement is displayed, the advertiser may be the content provider 20, manufacturer or any other appropriate advertiser. When an advertisement image is displayed in the movable image display region, the advertisement may include an advertisement expression or the company logo. The movable image display region may be implemented by an animation, using, for example, a flash program. The above configuration may be effectively used when network operator 10 or an advertiser wants to display a message or an advertisement to a user.

When the hot air balloon 230 is selected, detailed information relating to a corresponding message may be displayed, the home page of the advertiser may be connected to and displayed, and/or an advertisement provided by a corresponding advertiser may be displayed as the hot air balloon 230 flies across the screen. The hot air balloon 230 may be selected using, for example, a motion recognition remote controller 51 or by pressing a specific button, for example, the ENTER button or any other appropriate button.

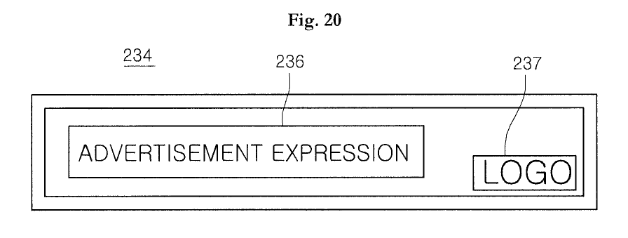

According to another embodiment, an advertisement image 210 may be displayed on an outdoor billboard or sign that is at a fixed location on the image display region 209 in FIG. 17. The advertisement image 210 may be provided by content provider 20 or network operator 10, and may be changed to fit image display region 209. As shown in FIG. 20, the image display region 209 may be tilted, for example, not facing towards the front of the screen as seen by a user to provide a perspective view. The network operator 10 or TV 30 may be provided with an advertisement expression from the content provider 20 or a predetermined advertiser. This expression may be appropriately formatted and transmitted to TV 30 to fit into image display region 209.

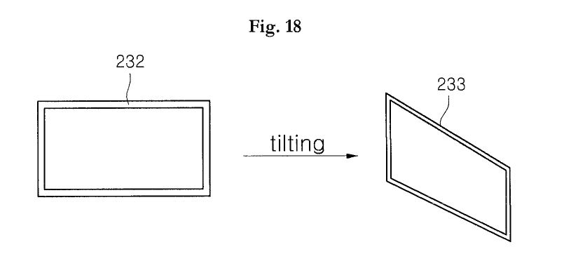

Referring to FIG. 18, the original image 232 provided by content provider 20 or network operator 10 may have a rectangular shape facing the front, whereas image 233 that will be displayed on the outdoor sign or billboard of FIG. 17 may be a tilted image that provides a perspective view. The image provided by the content provider 20 or the advertiser may be tilted, as shown in FIG. 18, and then transmitted to the network TV 30.

The fixed-type image display region and the movable image display region described above may be included in the background image 201. The background image 201 may, for example, be included in a firmware implementing the menu screen of the network TV 30, and the position, shape, and size, etc., of the image display region may be changed by updating the firmware.

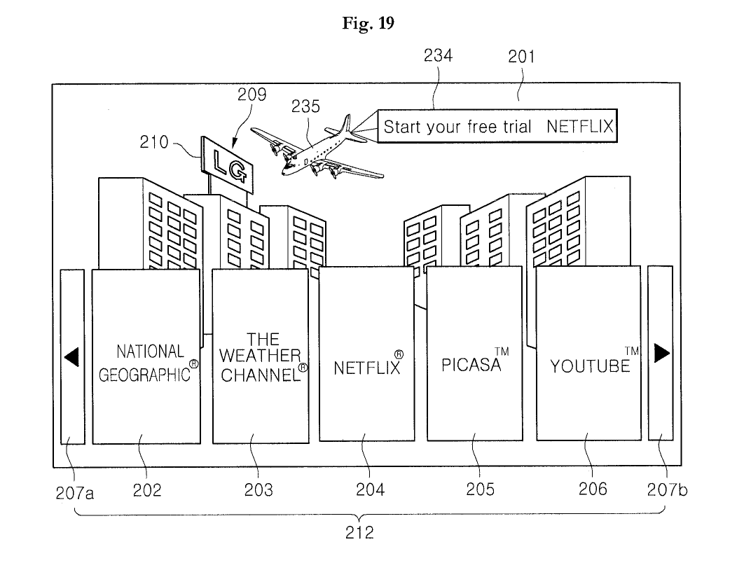

Referring to FIG. 19, according to one embodiment, after a predetermined time period passes with the menu screen displayed, it is possible to display a video of an airplane 235 with a banner 234 regardless of whether a user selects an icon 212. This is a type of a movable image display region. The video of the airplane 235 also relates to the city that is the subject of the background image 201 and displays the airplane 235 with the banner 234 flying in the sky. Any image or information may be displayed on the banner 234. When the airplane 235 is selected, for example, when a user presses a specific button, such as, the ENTER button or a button corresponding thereto, additional detailed information related the message displayed on the image may be displayed, detailed information related the advertisement may be displayed, or the network TV 30 may connect with the advertiser's server.

According to one embodiment, as shown in FIG. 20, the banner 234 may include a plurality of lower display regions, for example, an advertisement expression slot 236 and a company logo slot 237. It may be possible to implement the image in which the airplane 235 with the banner 234 flies across the screen, as shown in FIG. 19, with a display of an advertisement expression and a company logo image provided by the advertiser in the advertisement expression slot 236 and the company logo slot 237. Airplane 235 and the banner 234 may be included in firmware of the network TV 30, and the position, shape, and size, etc., may be changed by updating the firmware of the network TV 30.

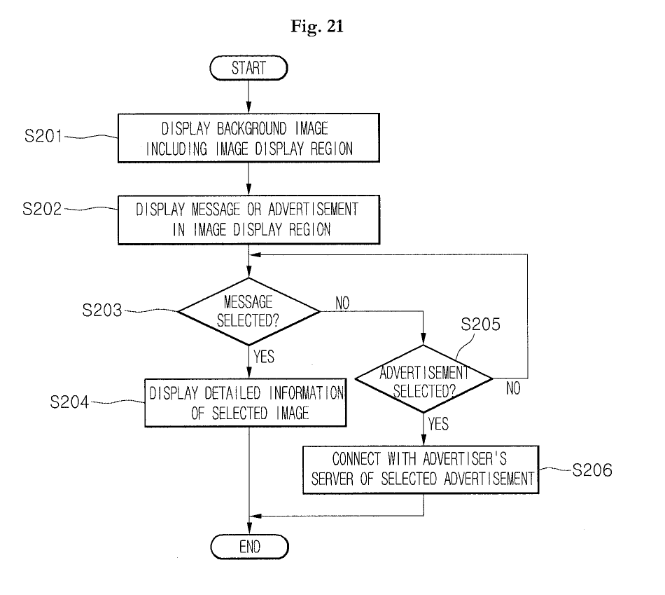

FIG. 21 shows operations in one embodiment of a method for displaying an image or advertisement on a menu screen in or relative to a background image 201. In step S201, a background image including an image display region where a message or an advertisement image is displayed may be displayed. The message may be a predetermined message for providing a user with information and the advertisement image may include a predetermined image that may be used for an advertisement, such as, an advertisement expression or company logo.

In step S202, a message or an advertisement image may be displayed in the image display region. Steps S201 and S202 may be simultaneously performed. The message or the advertisement may be provided from the network operator or content provider 20 of FIG. 1 or a predetermined advertiser.

In step S203, it may be determined whether the displayed message has been selected. If the message is selected, the detailed information related to the selected message may be displayed, in step S204.

If a message was not selected, in step S203, it is determined whether an advertisement has been selected, in step S205. If it is determined that the advertisement has been selected, the server of the selected advertiser is connected, in step S206. When the advertiser is a content provider 20, content may be provided after connecting to the server of the advertiser.

The system stands by when the user does not select any one of the message or the advertisement. According to an embodiment, it may be possible to automatically change the message or advertisement displayed in the image display region each time after a predetermined time period has passed.

According to one embodiment, the menu screen may be composed of a plurality of layers, wherein one layer may display an image, and it may be possible to transmits and display the effect generated by displaying the image to another layer. That is, it is possible to transmit the effect generated by one of the plurality of layers to another layer. It may be possible to provide a user with an active, funny, and interesting menu screen by making a plurality of layers exchange effects with each other.

In the embodiment shown in FIG. 15, as a video about weather is executed, the background image and icons may consecutively exchange effects. That is, as described with reference to FIG. 9, the menu screen may be composed of the layer 213 including the background image 201 and the layer 213′ including the icons 212. When a user selects icon 203 for weather information, an image in which it is snowing may be first displayed on the layer 213 that includes the background image 201. It may then be possible to transmit the effect generated on layer 213 to layer 213′ that includes the icons 212. That is, it is possible to display an image 214 of snow being collected on the icons 212 as snow falls in the background image 201. This corresponds to an embodiment that may display an image on one of two different layers and transmits the effect generated by displaying the image to the icons 212 included in another layer.

When a user selects icon 203 for weather information, the control unit of the network TV 30 first displays an image in which it snows on the layer including the background image 201. Thereafter, the control unit 50 estimates an image in which snows falls and collects on the icons 212 in consideration of the size and position of the icons 212, and performs control for displaying the estimated image. Moreover, the image of snow collecting on the icons 212 may be displayed on either layer 213 or layer 213′.

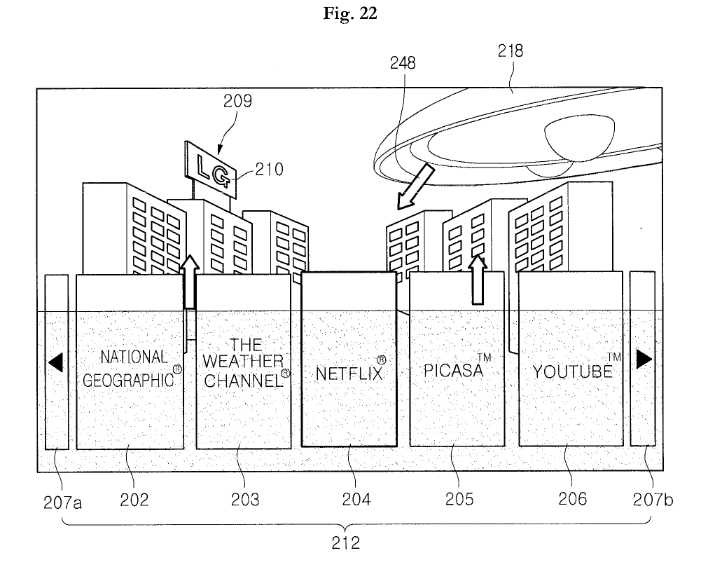

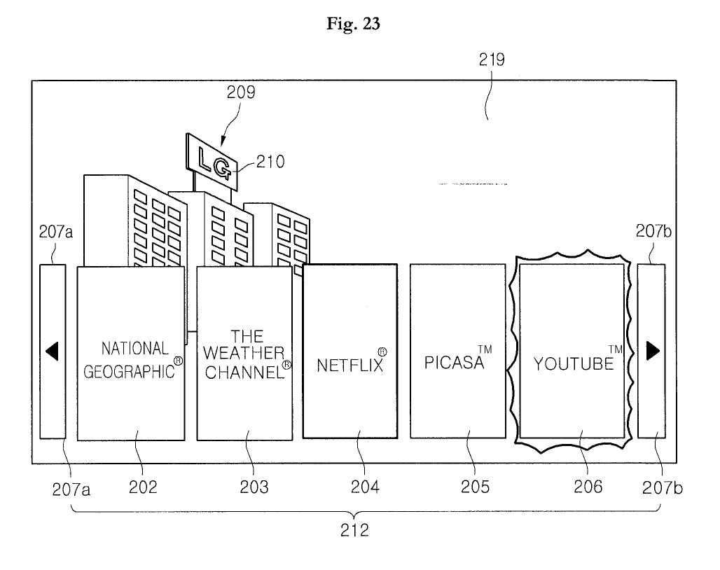

FIGS. 22 and 23 show screens that include effects performed among a plurality of layers. Referring to FIG. 22, upon selection of an icon 204 of the content provider 20 providing movie content, an image related to an object in a movie, for example, a large spaceship 218, may appear at an upper portion to be displayed. The image of the spaceship may be displayed on the layer that includes the background image 201. It is possible to gradually darken the screen while the shadow of the spaceship gradually increases in size from the lower end of the background image, and also gradually darken icons 212 from the lower end, as the spaceship 218 moves in the direction of an arrow 248. In this configuration, it may be possible to display the shadow influencing icons 212 on the layer that includes the icons 212. When an image having the moving spaceship is displayed, the control unit 50 of the network TV 30 may estimate a shadow image that will be displayed over icons 212 in consideration of the size and position of the icons 212, then display the shadow over the icons 212 on the basis of the estimated result.

Referring to FIG. 23, it is possible to show an image in which a character of a movie, for example, Spiderman 219 appears and makes an action hitting one 206 of the icons or shooting webs when a user selects icon 204 of the contents provider providing movie content. The image of Spiderman 219 may be displayed on the layer including the background image 201. It is possible to display an image in which icon 206 falls forward or webs are entangled by an action of Spiderman. It is possible to display the image in which icon 206 falls or webs are entangled on the layer including the icon. Various other animations or special effects may be possible based on the subject matter of the displayed images or advertisements.

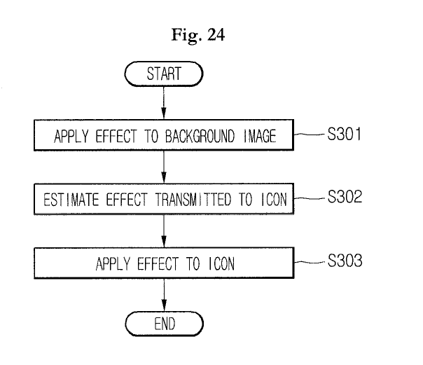

FIG. 24 shows operations included in one embodiment of a method for performing an effect in accordance with image display between layers in a menu screen. In step S301, an effect is applied to a layer including a background image in menu screen. In step S302, as the effect applied to the background image appears, effects that will be transmitted to the icons or images that will be displayed are estimated, and in step S303, the estimated effects are applied to the icons.

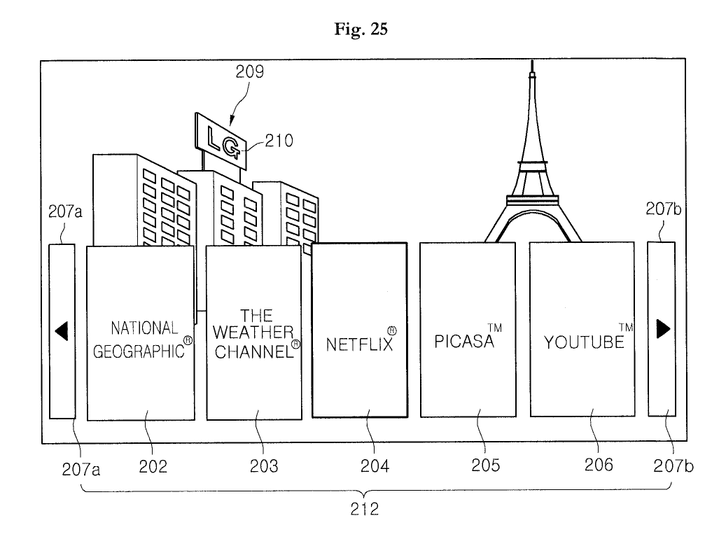

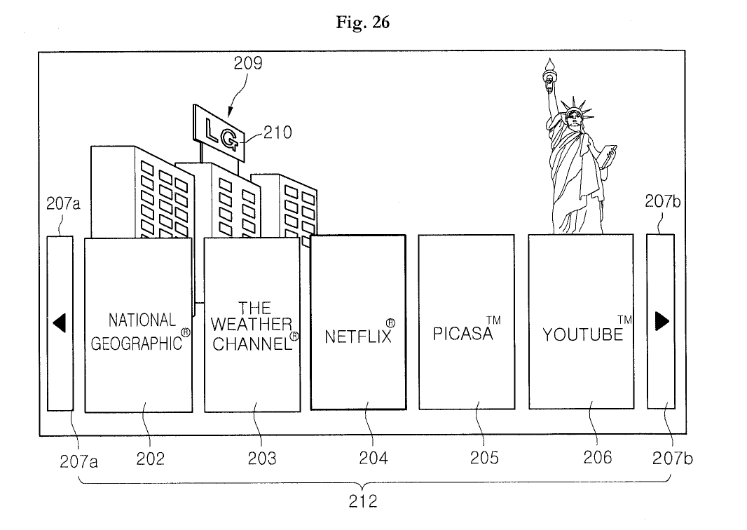

According to one embodiment, it is possible to acquire predetermined condition information of a user or the network TV 30, for example, information related to an area of the user, time, or seasons, and then automatically change the background image 201 in accordance with the condition information. For example, if the user is located in Paris as shown in FIG. 25, it is possible to display a background image 201 including the Eiffel Tower (or another landmark of Paris), and when the area is New York, it is possible to display a background image including the Statue of Liberty (or another landmark of New York) as shown in FIG. 26. The area information of a user may be set by the user, or received from the network operator 10 or the content provider 20 and stored in the network TV 30. Further, it is possible to change the background image 201 when the area information is changed by a user or when the user moves out of the area.

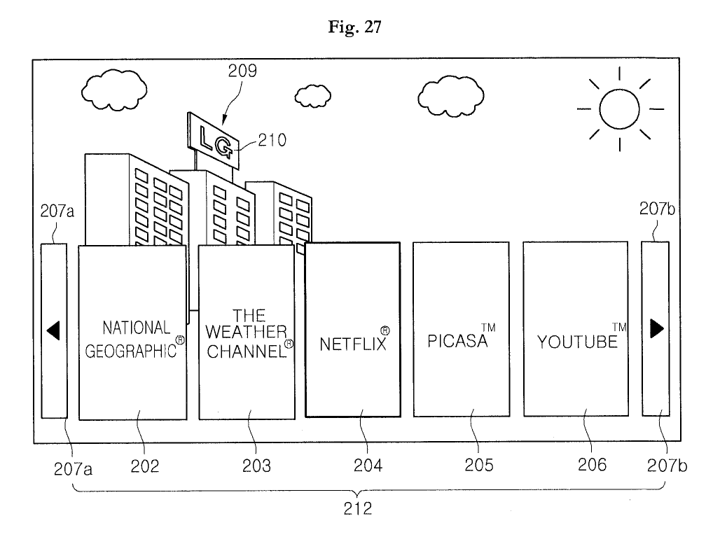

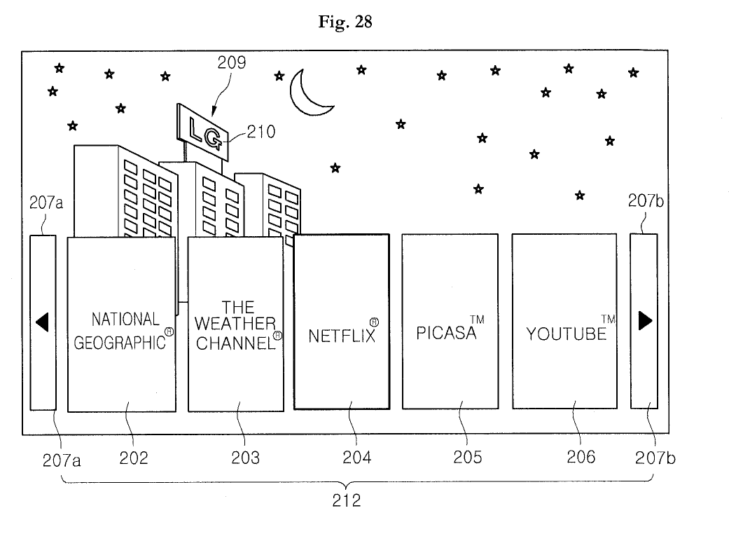

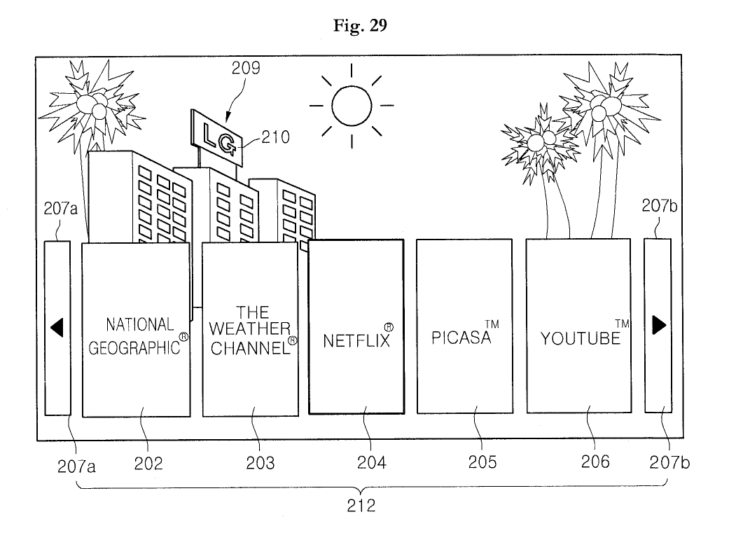

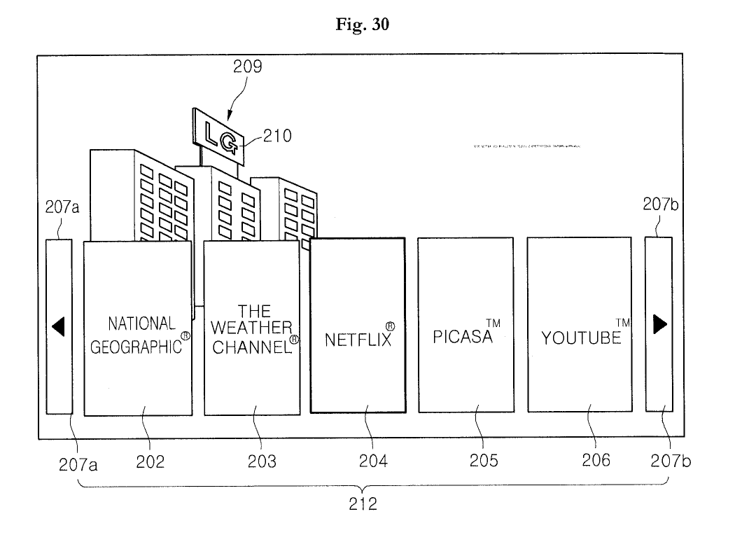

Further, as shown in FIGS. 27 and 28, it is possible to display a background image 201 including a night view or an image including a day view on the basis of the current time information. Further, the background image 201 may include an effect or image corresponding to a particualr season of the year, when that season currently exists. For example, it is possible to display a background image 201 that includes a summer view in the summer, as shown in FIG. 29, and a winter view in the winter, as shown in FIG. 30.

The time or weather information necessary for implementing the aforemtioned embodiments may be received, for example, from the network operator 10 and content provider 20 and/or may be extracted from a broadcast signal. In addition, an active menu screen may be displayed by changing the background image 201 in various ways in accordance with condition information related to the user or the network TV 30.

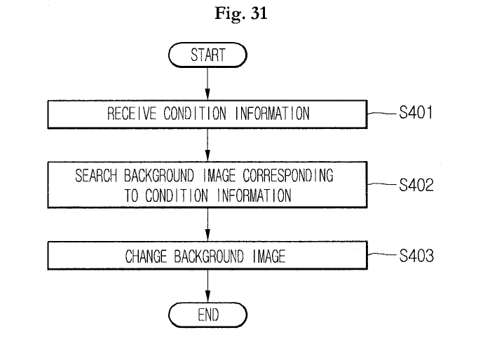

FIG. 31 shows operations included in one embodiment of a method for changing a background image in accordance with condition information from a user or a network TV 30. In step S401, a network TV 30 receives condition information of a user or the network TV 30 from network operator 10 or content provider 20. The condition information may include area information of a user, time and date, or seasonal information. Also, the condition information may be extracted from a broadcast signal that the network TV 30 has received or provided by the user.

In step S402, a background image corresponding to the condition information may be searched. In step S403, the background image may be changed into the searched background image. It is possible not to change the background image when the current displayed environment information is consistent with the background image. Further, the function may be deactivated when a user does not want to change the background image.

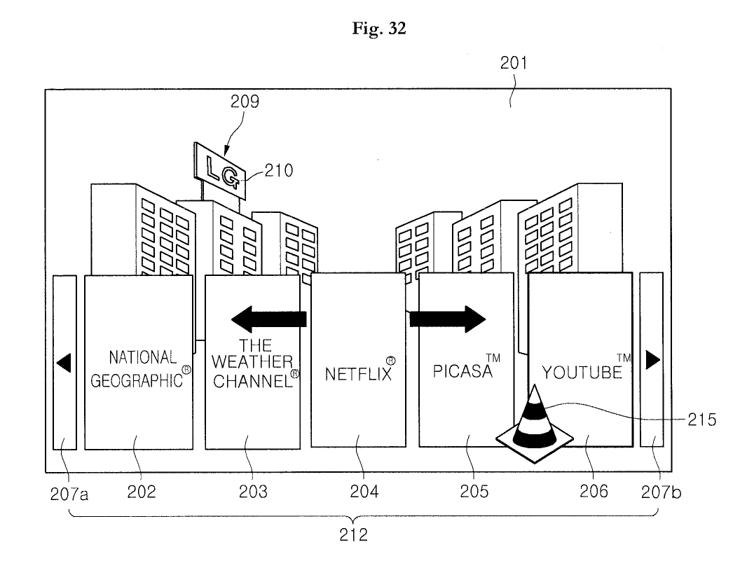

According to one embodiment, when a problem is detected while monitoring the service condition of each content provider 20 or the network condition of the network TV 30, it is possible to display information providing notification of or a reason for the problem on the menu screen. When a content provider 20 cannot provide a service due to server check or maintenanace, it is possible to display a notice that service is unavailable on the menu screen. For example, as shown in FIG. 32, it is possible to display that service is unavailable on the corresponding icon 206 to display an intuitive image, for example, a graphic image 215, “Under Construction.”

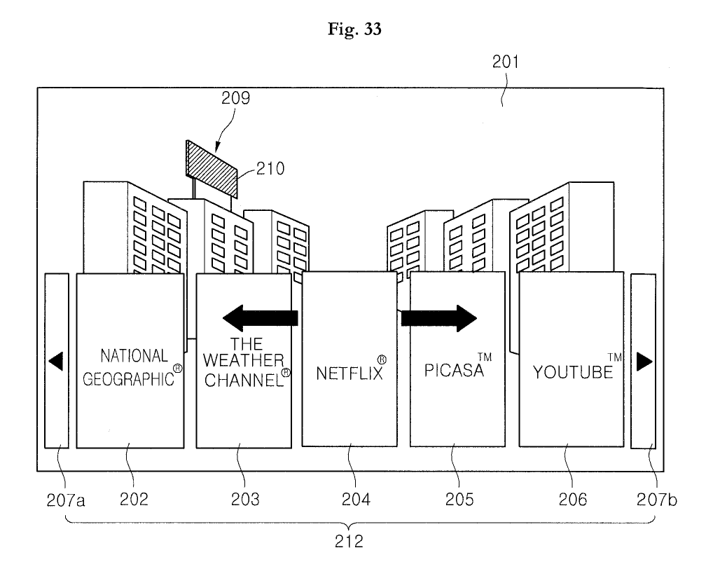

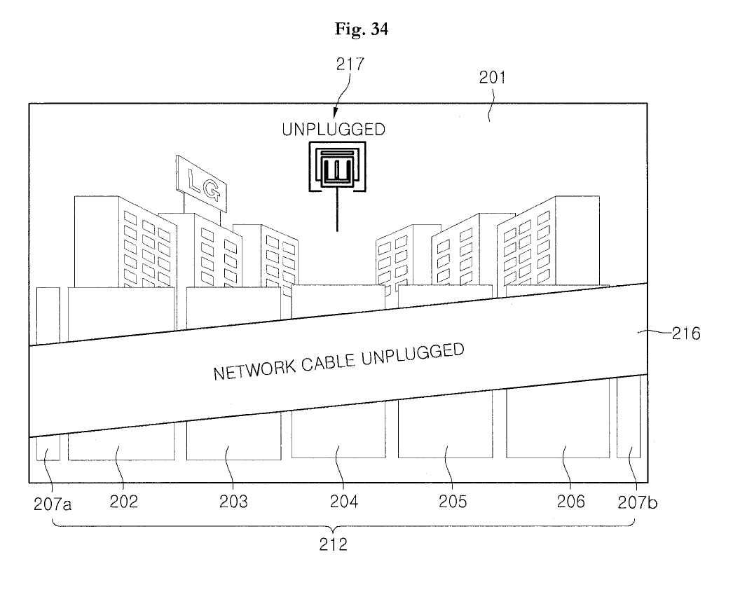

Further, according to one embodiment, it is possible to display information related to the connection condition or network status between the network TV 30 and the content provider 20 or the network operator 10 on the menu screen. For example, as shown in FIG. 33, with the NetCast™ mode executed, it is possible to vary the brightness of the advertisement image 210 displayed in the image display region 209 included in the background image 201 in accordance with the network connection condition. That is, it is possible to brighten the advertisement image 210 when the network connection condition is good, and it is possible to darken the advertisement image 210 when the connection condition is poor. The above configuration may enhance the user interface and provide a user with or otherwise engage the user as compated to than when displaying the network condition by using a common text or graph, etc. Further, according to one embodiment, when a user attempts to execute the NetCast™ mode, and the network cable of the network TV 30 is either unplugged or the interface is not operated as shown in FIG. 34, it may be possible to display this condition throughout the menu screen. In this case, it is possible to display a menu screen that is more intuitive and which provides a user with interest, as when compared to notifying the user with a common text, by displaying a predetermined graphic image 217 to indicate that the cable is unplugged. For exmaple, a block tape 216 used in general construction sites as shown in FIG. 34 may be displayed. In this case, because the NetCast™ service is completely unavailable, it is possible for a user to intuitively be informed of this problem by translucently or dimly displaying the images on the menu screen, that is, the background image 201 and/or the icons 212, except for expressions 216 and 217 informing that the network interface is not operated.

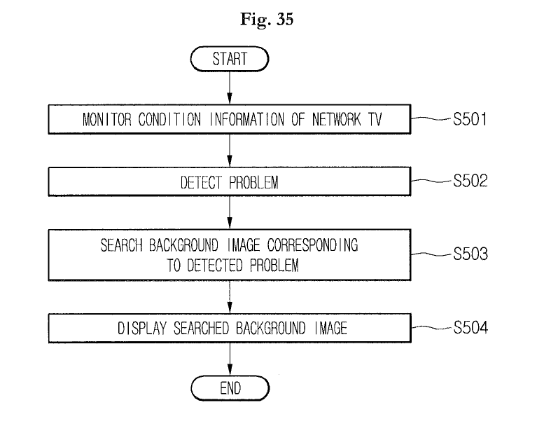

FIG. 35 shows operations included in one embodiment of a method for changing a menu screen in accordance with a condition of a content provider or a network TV 30. The condition information of the network TV 30 may be monitored in step S501, and a problem may be detected in step S502. A background image corresponding to the detected problem may be searched in step S503, and the image corresponding to the detected problem may be displayed in step S504.

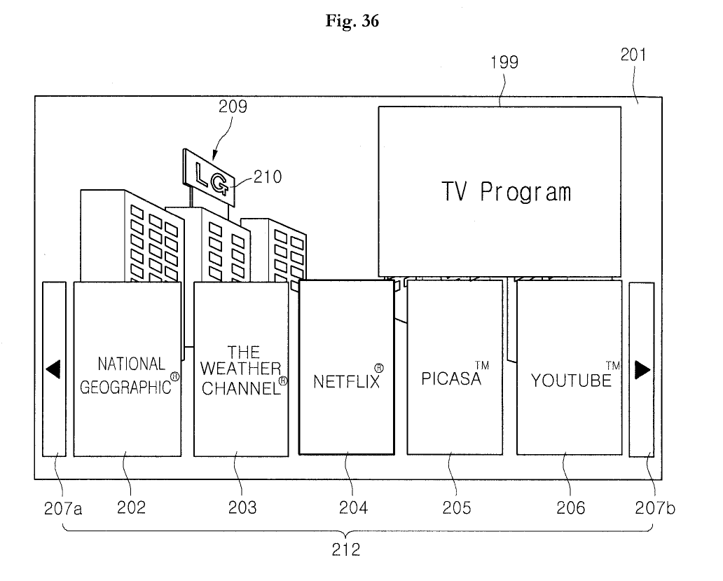

In accordance with another embodiment as shown in FIG. 36, a television signal containing a television program 199 may be displayed at the same time the menu screen containing the background image 201 and content provider icons 212 are displayed. The television program 199 may be displayed at a fixed or adjustable region in the background image 201, at another location within the menu screen, or at an area outside of the menu screen. For example, the television program 199 may be displayed in a picture-in-picture signal area of the television screen.

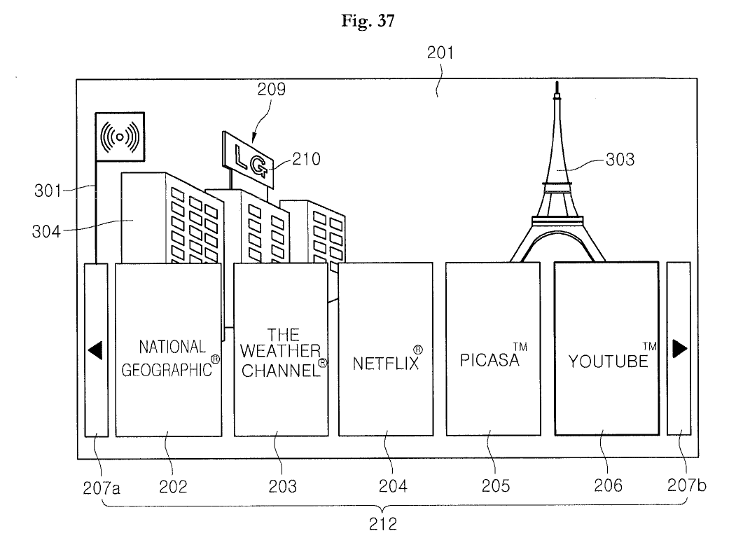

According to an embodiment of the present disclosure, by configuring the menu screen with a plurality of templates and changing each template, a user may edit the menu screen according to his/her tastes or needs. FIG. 37 shows an example of a menu screen according to an embodiment. FIG. 37 is similar to the menu screen of FIG. 6, but unlike the menu screen of FIG. 6, a flag 301 indicating a network connection status and a landmark for a city, for example, the Eiffel Tower 303, are displayed. An indicator indicating a network access state or network status of the network TV 30 may be displayed in the flag 301 of FIG. 37. The network interface unit 45 of the network TV 30 may measure a signal intensity and display the indicator on the basis of the data thereof.

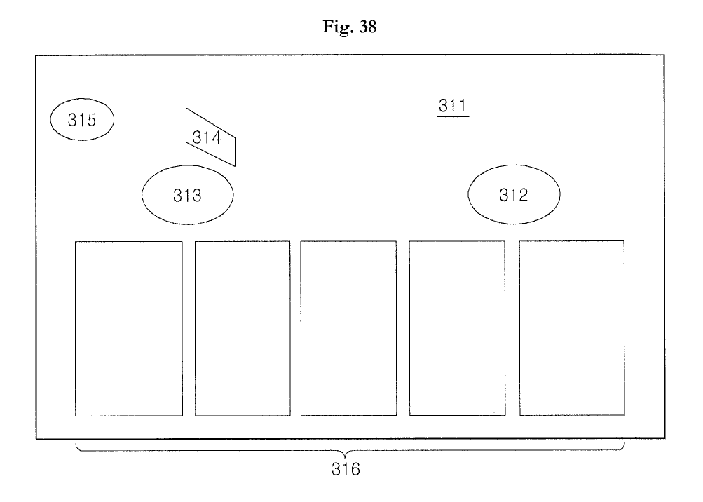

According to this embodiment, the menu screen of FIG. 37 may be implemented by using a plurality of templates as shown in FIG. 38. Comparing FIG. 37 with FIG. 38, the background image 201 may be implemented based on a template 311, the Eiffel Tower image 303 may be based on a template 312, the building image 304 may be based on a template 313, the advertisement image 210 may be based on a template 314, the flag image 301 may be based on a template 315, and the icons 212 may be based on a template 316. Accordingly, the menu screen of FIG. 31 may be implemented by displaying the image in each of the templates 311 to 316.

When an editing mode of a menu screen of a NetCast™ mode is executed, the menu screen editing mode of FIG. 38 is displayed to display the templates of the background image. According to this embodiment, the image may be displayed in each of the templates 311 to 316 and the attributes of the templates 311 to 316 and the images displayed in the templates 311 to 316 may be edited or changed. The form, location or position, and size of the templates may also be modified.

According to this embodiment, the form or shape of the template may be modified in the template 314. For example, when the template 314 is tilted in a predetermined direction, the image displayed in the template 314 may also be displayed to tilt in the predetermined direction. The tilted form or shape of the image may provide an effect to show a perspective view.

The template 314 may correspond to the fixed-type image display region 209 of the embodiments shown in FIGS. 17 to 20. The template 314 may be configured to display an advertisement image such as the fixed-type image display region 209, and may change the advertisement image every predetermined time period or for a predetermined duration. Further, an advertisement display function may be deactivated when the template is capable of displaying the advertisement image.

In addition, the template 315 may display an indicator image that may vary depending on a performance state or status of a predetermined function of the network TV 30. For example, an attribute of the image may be edited in the template 315 to set a type of status information or function to be displayed by the indicator image. Further, the template 312 may be used to display the landmark image of a user's location, and may be displayed based on information received regarding the user's location. In addition, the basic template 311 may correspond to the background image 210 of the embodiment illustrated in FIGS. 17 to 20. The basic template 311 may be configured to be changed depending on the user's location information, weather information, and other user information to change or customize the display of the background image 201.

As described above, the attributes of the templates 311 to 316, the attributes of the images displayed in the templates 311 to 316, including display methods or types of status information (time interval, duration etc.) of the display images, may be set by the user. Further, the locations of the templates 311 to 316 may be changed. The editable template may also include the template 316 in which images of icons 212 associated with content servers are displayed.

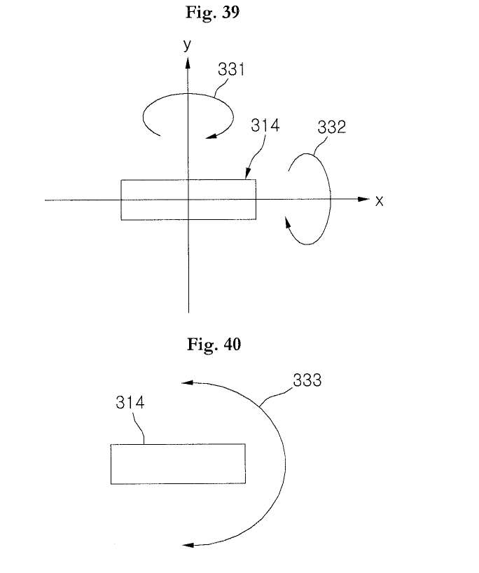

FIGS. 39 and 40 show an embodiment in which the configurations of templates may be edited. In this embodiment, a directional orientation of the template 314 may be changed or modified to rotate the template 314. When an image is displayed in a template, the front of the screen may be set as the default. As shown in FIG. 39, the direction in which the template 314 faces may be changed by pivoting the template vertically 332 around an x axis or horizontally 331 around a y-axis with respect to the screen of the network TV 30. Further, as shown in FIG. 40, the template may be pivoted or rotated parallel 333 to the screen of the network TV 30. By pivoting the template as described above, the direction in which the image displayed in the template faces may be changed accordingly.

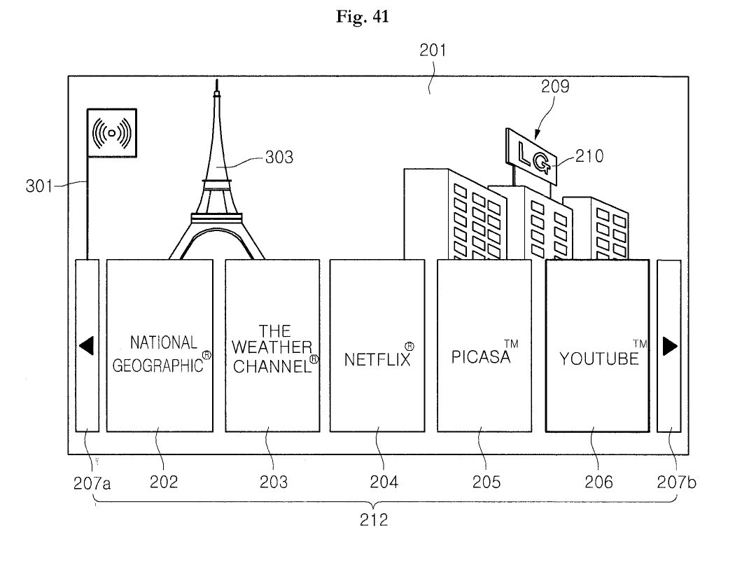

According to this embodiment, the positions of the templates on the menu screen may also be changed. FIG. 41 shows an embodiment in which the position of the template 312 and the positions of the templates 313 and 314 as shown in FIG. 38 have been interchanged with each other. When the user changes the positions of the templates, the positions of the images displayed in the templates are also changed. In FIG. 41, the positions of the building image 304 and the billboard image 210 have been interchanged with the position of the Eiffel Tower image 303.

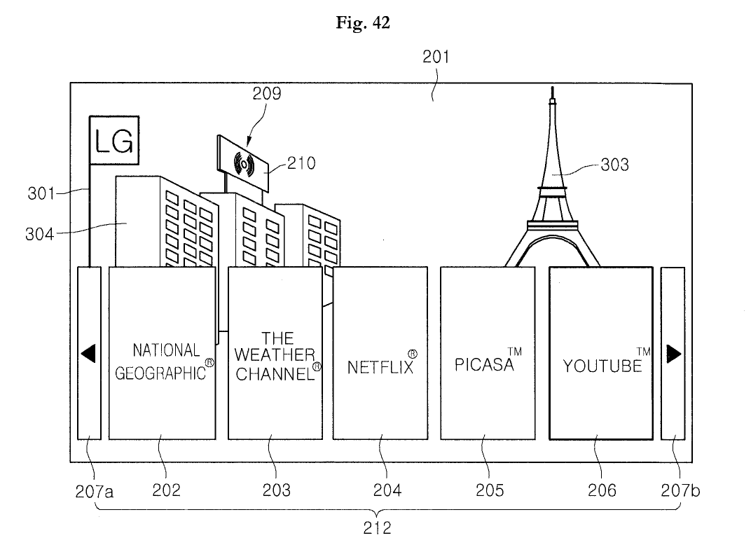

FIG. 42 shows an embodiment in which images displayed in templates are changed. When an indicator indicating a network state of the network TV 30 is designated and displayed in the template 314 of FIG. 38, and the billboard image 210 is designated and displayed in the template 315, the positions of the billboard image 210 and the position of the indicator image 301 are interchanged with each other on the menu screen, as shown in FIG. 42. The positions and sizes of the templates, images which may be displayed in the templates, as well as a method of displaying the images may be variously changed.

A template may be selected by using the menu screen editing screen of FIG. 38 and the configurations of the templates may be changed and stored to thereby edit the menu screen. The edited menu screen may be designated as a user menu screen. For example, a user may store the configuration as shown in FIG. 41 as a user menu screen 1 and the configuration as shown in FIG. 42 as a user menu screen 2.

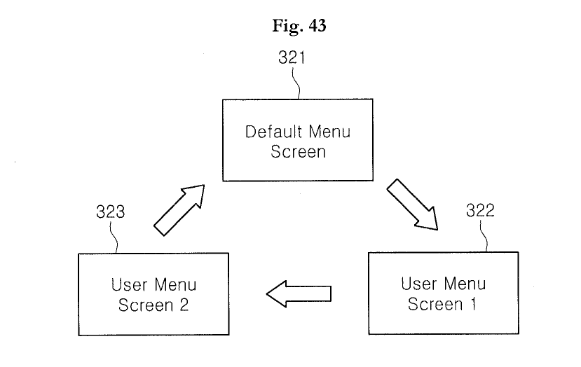

A plurality of edited menu screens may be stored and the menu screen may be toggled or switched between them as necessary. Further, as shown in FIG. 43, the menu screen may be toggled between the default menu screen 321 and the user menu screens 322 and 323 which were originally set in the network TV 30. For example, when a command to change a menu screen is inputted while the default menu screen 321 is displayed, the menu screen 321 may be toggled to the user menu screen 1 322 and the user menu screen 2 323. Further, one menu screen among the plurality of menu screens may be selected for designation as a basic menu screen or a default menu screen to be displayed at the time of executing the NetCast™ mode.

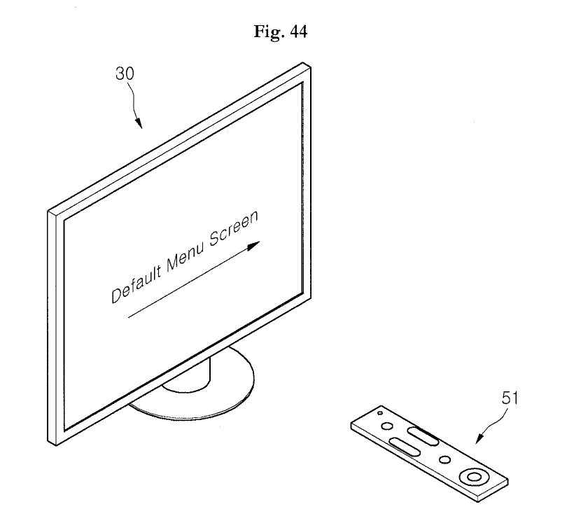

According to the embodiment, a command to change the menu screen may be inputted by a gesture using the above-mentioned motion recognition remote controller 51. For example, when a user points towards a network TV 40 by means of the motion recognition remote controller 51 and makes a gesture to cross the screen vertically or horizontally, as shown in FIG. 44, the gesture may be recognized and the menu screen may be toggled. For example, a user may point the motions recognition remote controller 51 at a first location of the menu screen and move the controller across the menu screen to a second position. This gesture input may cause the menu screen to toggle.

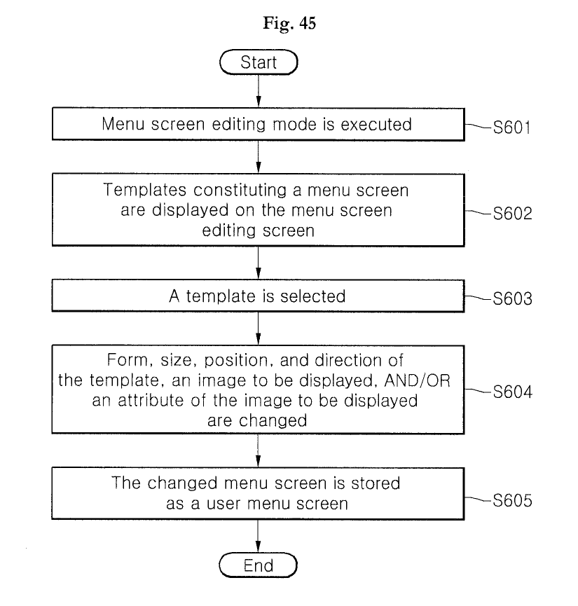

FIG. 45 is a flowchart showing a method of editing a menu screen according to an embodiment. When a menu screen editing mode is executed in step S601, the menu screen editing screen may be displayed as shown in FIG. 37 in step S602. Templates 311 to 316 may be displayed on the menu screen editing screen to allow configuration of the menu screen. One of the plurality of templates may be selected in step S603 to change or edit one or more of the form, size, position, and/or direction of the template, an image to be displayed, an attribute of the image to be displayed, for example, a time interval to be displayed, or the type of a state value which the image reflects if the image is an indicator image, in step S604. At step S605, the changed menu screen may be stored as a user menu screen.

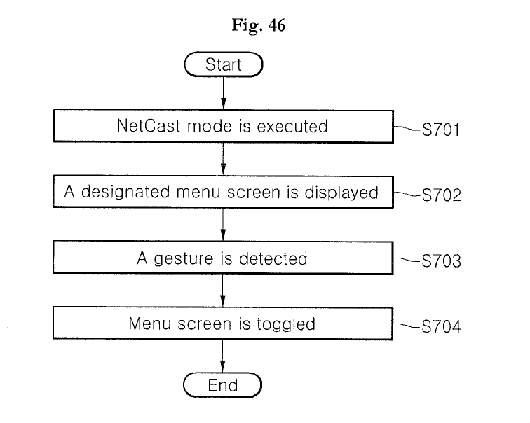

FIG. 46 is a flowchart showing a method of storing a plurality of menu screens and changing or toggling the menu screens between each other according to an embodiment. When a NetCast™ mode is executed in step S701, a menu screen designated as a basic screen among the plurality of menu screens may be displayed. At step S703, when a gesture input for changing the menu screen is detected, for example, the gesture as shown in FIG. 44, the menu screen is toggled at step S704 in response to the input.

A display device is broadly described and embodied herein, and may include an interface configured to allow receipt of content from one or more content provider servers; a menu screen having a plurality of images, wherein the plurality of images may include or more of a plurality of icons corresponding to the one or more content provider servers, and wherein each of the plurality of images are associated with a plurality of templates for configuring the plurality of images; an interface configured to receive an input to edit the at least one of the plurality of templates; a controller to control an edit of the configuration of the at least one of the plurality of templates in response to the user input, wherein the controller may stores a modified menu screen having the edited template; and a display configured to display the menu screen or the modified menu screen.

In the display device the configuration of the at least one template may include: configuring a corresponding image to be displayed, an attribute of the corresponding image to be displayed, and at least one of a form, position, size, and orientation of the template; wherein a change in the configuration of the at least one template may change a configuration of the corresponding image displayed in the modified menu screen. Here, the corresponding image to be displayed may be associated with the one or more content provider servers, wherein the corresponding image is received from the one or more content provider servers to edit the configuration of the template corresponding to the corresponding image. The attribute of the corresponding image may include a duration of time for displaying the image or a type of status information to be displayed by the corresponding image; and the type of status information may include a network status of the display device.

In the display device the controller may be configured to toggle the display between the menu screen and the modified menu screen in response to the user input; and wherein the input is a user gesture, and wherein the gesture includes moving a motion recognition remote controller pointed at a first position on the display to a second position on the display. The display device may further include a broadcast signal processor configured to receive a broadcast signal for display on the display device; wherein the display device may be a network TV configured to display the broadcast signal and to display content retrieved over the network from the one or more content provider servers.

A method of editing a menu screen provided on a display device is broadly described and embodied herein, including initiating an edit mode to edit the menu screen, wherein the menu screen may include a plurality of images and a plurality of templates for configuring the pluarality of images, and wherein the plurality of images may include a plurality of icons corresponding to one or more content providers; displaying the plurality of templates in the edit mode; editing a configuration of at least one of the plurality of templates in accordance with an input; and storing the menu screen configured based on the edited template.

In this method editing the configuration of the at least one of the plurality templates may include at least one of the plurality of images, an attribute of the at least one of the plurality of images, and at least one of a form, position, size, and orientation of the template; wherein editing the attribute of the at least one of the plurality of images may include editing a duration of time for displaying the at least one of the plurality of images or a type of status information to be displayed by the at least one of the plurality of images; and may further include storing the edited menu screen as a user menu screen.

The method may further include receiving the input, wherein the input is a user gesture input; and toggling the display between the menu screen and the edited menu screen in response to the user gesture input. The user gesture input may include pointing a motion recognition remote controller at a first position on the menu screen and moving the motion recognition remote controller across the menu screen to point at a second position on the menu screen. The method may further include displaying a broadcast signal received at the display device, wherein display device is a network TV; and displaying content received over the network from the one or more content provider servers.

A method of toggling a menu screen on a display device is broadly described and embodied herein, including initiating an operation mode of the display device to receive content from one or more content provider servers through the network; displaying one of a plurality of menu screens each having a plurality of images, wherein the plurality of images include one or more of a plurality of icons corresponding to the one or more content provider servers, and wherein each of the plurality of images are associated with a plurality of templates for configuring the plurality of images; detecting an input to toggle the displayed menu screen; and toggling the displayed menu screen to another one of the plurality of menu screens.

In this method the input may include pointing a motion recognition remote controller at a first position on the menu screen and moving the motion recognition remote controller across the menu screen to point at a second position on the menu screen; wherein at least one of the plurality of menu screens may be edited through configuration of a corresponding one of the plurality of templates.

Other than the embodiments described above, there may be content providers that provide various types of content in a network TV, and the images relating to content that are displayed each time icons of the content providers are selected may be changed. A display device connectable to a network may include a network interface unit configured to receive contents by being connected with a content provider server through a network; a user interface unit configured to be constituted by templates capable of displaying images and receive user input to edit menu screen including templates capable of displaying a plurality of icons indicating content providers; a control unit configured to control to edit the configurations of the templates in accordance with the user input and store the menu screen configured by the edited template; and a display unit configured to display the menu screen and display the menu screen configured by the edited template in accordance with the control unit's control.

A display device connectable to a network may include a network interface unit configured to receive contents by being connected with a content provider server through a network; a user interface unit configured to include of a plurality of templates capable of displaying images and receive user gesture input to change menu screens including a plurality of icons indicating content providers; a control unit configured to control to change and display the menu screen to another menu screen in accordance with the user input; and a display unit configured to display the menu screen and change and display the menu screen in accordance with the control unit's control.

A method of editing a menu screen in a display device connectable to a network may include executing an edit mode of a menu screen that includes a plurality of templates capable of displaying images and including a plurality of icons indicating content providers; displaying the plurality of templates; editing the configuration of each of the templates in accordance with user input; and storing the menu screen configured based on the edited template.

A method of changing a menu screen in a display device accessible to a network may include a method of changing a menu screen in a display device connectable to a network including executing an operation mode in which content services are received from a plurality of content providers through the network; displaying one of a plurality of menu screens including a plurality of templates capable of displaying images and including a plurality of icons indicating content providers; detecting user's gesture input to change the menu screen; and displaying a menu screen other than the displayed menu screen.

According to an embodiment of the present disclosure, it may be possible to provide a method of displaying and selecting a menu to a user in a network TV system. According to the embodiment of the present disclosure, it may be possible to provide an effective method of transferring a message or an advertisement in the network TV system. According to an embodiment of the present disclosure, it may be possible to provide a network TV in which a user may edit a menu screen and may store the menu screens edited by the user and change the menu screens in accordance with user's need.

The embodiments described herein may be implemented by a program that is executed by a common processor, such as a computer, and may be implemented by using a flash application or a 3D-flash application. The implemented program may be stored in a computer-readable recording medium in the network TV. Examples of the computer-readable recording media include a ROM, a RAM, a CD-ROM, a magnetic tape, a floppy disk, and an optical data storage. In addition, the program may be implemented in a recording medium in the form of a carrier wave (for example, transmission through the Internet).

Further, the computer-readable recording media may be distributed on computer systems connected through the network, and thus the computer-readable recording media may be stored and executed as computer-readable code in a distribution scheme. Further, functional programs, codes, and code segments for implementing a method of receiving broadcast signals may be easily inferred by programmers in the related art.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A display device, comprising:
an interface configured to allow receipt of content from one or more content provider servers;
a menu screen having a plurality of images, wherein the plurality of images comprise one or more of a plurality of icons corresponding to the one or more content provider servers, and wherein each of the plurality of images are associated with a plurality of templates for configuring the plurality of images;
an input interface configured to receive an input to edit the at least one of the plurality of templates;
a controller to control an edit of configuration of the the at least one of the plurality of templates in response to the input, wherein the controller allows storage of a modified menu screen having the edited template; and
a display configured to display the menu screen or the modified menu screen.

2. The display device of claim 1, wherein the configuration of the at least one template includes configuring a corresponding image to be displayed, an attribute of the corresponding image to be displayed, and at least one of a form, position, size, and orientation of the template.

3. The display device of claim 2, wherein a change in the configuration of the at least one template changes a configuration of the corresponding image displayed in the modified menu screen.

4. The display device of claim 2, wherein the corresponding image to be displayed is associated with the one or more content provider servers, and wherein the corresponding image is received from the one or more content provider servers to edit the configuration of the template corresponding to the corresponding image.

5. The display device of claim 2, wherein the attribute of the corresponding image includes a duration of time for displaying the corresponding image or a type of status information to be displayed by the corresponding image.

6. The display device of claim 5, wherein the type of status information includes a network status of the display device.

7. The display device of claim 1, wherein the controller is configured to toggle the display between the menu screen and the modified menu screen in response to the input.

8. The display device of claim 7, wherein the input is a user gesture, wherein the user gesture comprises moving a motion recognition remote controller pointed at a first position on the display to a second position on the display.

9. The display device of claim 1, further comprising a broadcast signal processor configured to receive a broadcast signal for display on the display device.

10. The display device of claim 9, wherein the display device is a network TV configured to display the broadcast signal and to display content retrieved over the network from the one or more content provider servers.

11. A method of editing a menu screen provided on a display device, comprising:
initiating an edit mode to edit the menu screen, wherein the menu screen includes a plurality of images and a plurality of templates for configuring the plurality of images, and wherein the plurality of images comprise a plurality of icons corresponding to one or more content providers;
displaying the plurality of templates in the edit mode;
editing a configuration of at least one of the plurality of templates in accordance with an input; and
storing the menu screen configured based on the edited template.

12. The method of claim 11, wherein editing the configuration of the at least one of the plurality templates includes editing at least one of the plurality of images, an attribute of at least one of the plurality of images, and at least one of a form, position, size, and orientation of the template.

13. The method of claim 12, wherein editing the attribute of at least one of the plurality of images includes editing a duration of time for displaying at least one of the plurality of images or a type of status information to be displayed by at least one of the plurality of images.

14. The method of claim 11, further comprising storing the edited menu screen as a user menu screen.

15. The method of claim 11, comprising:
receiving the input, wherein the input is a user gesture input; and
toggling the display between the menu screen and the edited menu screen in response to the user gesture input.

16. The method of claim 15, wherein the user gesture input comprises pointing a motion recognition remote controller at a first position on the menu screen and moving the motion recognition remote controller across the menu screen to point at a second position on the menu screen.

17. The method of claim 11, further comprising:
displaying a broadcast signal received at the display device, wherein display device is a network TV; and
displaying content received over the network from the one or more content provider servers.

18. A method of toggling a menu screen on a display device, comprising:
initiating an operation mode of the display device to receive content from one or more content provider servers;
displaying one of a plurality of menu screens each having a plurality of images, wherein the plurality of images comprise one or more of a plurality of icons corresponding to the one or more content provider servers, and wherein each of the plurality of images are associated with a plurality of templates for configuring the plurality of images;
detecting an input to toggle the displayed menu screen; and
toggling the displayed menu screen to another one of the plurality of menu screens.

19. The method of claim 18, wherein the input comprises pointing a motion recognition remote controller at a first position on the menu screen and moving the motion recognition remote controller across the menu screen to point at a second position on the menu screen.

20. The method of claim 19, wherein at least one of the plurality of menu screens is edited by the user through configuration of a corresponding one of the plurality of templates.
